(19) United States
(12) Patent Application Publication
(10) Pub. No.: US 2013/0016584 A1
(43) Pub. Date: Jan. 17, 2013

(54) METHODS AND APPARATUS FOR OBTAINING SENSOR MOTION AND POSITION DATA FROM UNDERWATER ACOUSTIC SIGNALS

(71) Applicants: Jiangying Zhou, Durham, NC (US); Karen Zachery, RaLeigh, NC (US); Ming Qian, Cary, NC (US); Alexander Bogdanov, Simi Valley, CA (US)

(72) Inventors: Jiangying Zhou, Durham, NC (US); Karen Zachery, RaLeigh, NC (US); Ming Qian, Cary, NC (US); Alexander Bogdanov, Simi Valley, CA (US)

(73) Assignee: Teledyne Scientific & Imaging LLC

(21) Appl. No.: 13/184,374

(22) Filed: Jul. 15, 2011

(51) Int. Cl. G01S 15/89

(52) U.S. Cl. 367/88

(57) ABSTRACT

Technologies are provided to recover motion, position, or navigation data of underwater sensors using bathymetry data. A method includes iteratively fitting data obtained by an underwater sensor from interactions between acoustic signals and an underwater floor, and deriving at least one of motion, position, or navigation data of the underwater sensor from the fitting. A standalone sonar can use the methods, systems, apparatuses, and computer programs to realize the derivation of motion, position, or navigation data without a position or motion sensor.

### STATEMENT OF GOVERNMENT INTEREST

The present invention was made, at least in part, with support from the United States Office of Naval Research, contract number N00014-06-C-0161. The Government may have certain rights in this invention.

### BACKGROUND

Underwater sonars use acoustic signals to detect underwater objects, image seafloors or lakebeds. A sonar can be tethered/towed from a platform, such as a ship, anchored to the hull of the ship, or part of an unmanned underwater vehicle (UUV) or autonomous underwater vehicle (AUV).

### SUMMARY

Both universality and low cost are desirable attributes of techniques for underwater sensing. Accordingly, systems and methods to extract the motion signature from the uncorrected bathymetry data are described herein. In accordance with some embodiments, the bathymetry sensor may not only produce a motion-corrected bathymetry solution, but may also generate a motion parameter estimation.

In towed and AUV systems, there can be a tight coupling between pitch and heave, and heading roll and sway. In accordance with some embodiments, by establishing correlations among these motions, the number of uncertainties in the motion estimation can be reduced. Further, with a dynamic model of the towed systems or AUVs in combination with a state of the sea, the errors in the motion estimation can also be limited. By combining these bounding functions with the motion-induced artifacts in the bathymetry data, motion parameters of the sensors and navigational data can be derived from these bathymetry data, particularly from the traditionally undesired artifacts.

In illustrative embodiments, motion signatures can be extracted from the uncorrected bathymetry data, and the relationships between sensor motions and the bathymetry data are derived. Procedures for extraction of motion from the bathymetry data may be provided and applied to multiple sets of bathymetry data collected under various seafloor terrain conditions. Sensitivity of motion estimation computation can be correlated with data noise, sensor resolution, and terrain geometry variations.

In one example, a roll motion can be recovered from bathymetry data, up to a constant calibration offset, under most terrain conditions. Heave motion can also be recovered up to a multiplicative factor.

In one aspect, a method is provided including iteratively fitting data obtained by an underwater sensor from interactions between acoustic signals and an underwater floor; and deriving at least one of motion, position, or navigation data of the underwater sensor from said fitting. In one embodiment, the method further includes, prior to the iteratively fitting, selecting the data by removing data points near nadir, data points near a data range limit, and data points with weak amplitudes.

The fitting can include removing data having a deviation higher than a first threshold from a first polynomial; fitting remaining data to a second polynomial; reducing the first threshold to a second threshold; and removing data having a deviation higher than the second threshold from the second polynomial. The first and second polynomials can be obtained from least-square fitting.

In an embodiment, the method further includes repeating said fitting remaining data to a second polynomial until deviations of data, survived from said removing data having a deviation higher than the second threshold from the second polynomial, are within a current threshold.

In an embodiment, the iteratively fitting data includes iteratively fitting the data obtained from a single discrete transmission of the acoustic signals.

In an embodiment, the data are obtained from multiple discrete transmissions of the acoustic signals, the method further comprising determining whether the data are sufficient for statistics over the multiple discrete transmissions. The method can further include applying a Bayesian statistics to the data obtained from the multiple discrete transmissions. The application of Bayesian statistics can include applying a recursive filter. In one embodiment, the recursive filter includes a Kalman filter. The application of the Kalman filter can include initializing the filter; generating a prior density; generating a posterior; incrementing a time index; and returning to said generating a prior density.

In some embodiments, the Kalman filter includes an Unscented Kalman Filter. The application of the Unscented Kalman Filter can include: deterministically calculating a set of weighted sigma points using a mean and square-root decomposition of a covariance matrix constructed from the data; propagating the set of weighted sigma points a true nonlinear function using a functional evaluation to generate a posterior sigma point set; and approximating posterior statistics using tractable functions of the posteriori signal point set.

In some embodiments, the method further includes providing at least one of a dynamic model of the motion of the sensor or a dynamic model of the underwater floor variation.

In some embodiments, the derived motion, position, or navigation data include a first component from the motion of the sensor; and a second component from the underwater floor variations. The method can further include separating the first and second components from the data. The method can further include the motion data of the sensor from the first component. In one embodiment, the motion comprises a heave motion, and wherein the second component comprises a multiplicative component introduced by a slope of the underwater floor to the first component, the method further comprising removing the multiplicative component. In another embodiment, the motion includes a roll motion, and the second component includes an additive component introduced by a slope of the underwater floor to the first component, the method further including removing the additive component.

The deriving can be performed without a motion or position sensor. The motion data can include at least one of a roll motion or a heave motion.

In some embodiments, the method further includes applying spectrum filtering to the derived motion, position, or navigation data to correct for underwater floor variations. The application of spectrum filtering can include applying a low-pass filter.

In some embodiments, the method further includes performing a joint state-parameter estimation over the data to separate a bias in the data introduced by the underwater floor variation. The method can further include dividing a track in the underwater floor into a plurality of segments each having a substantially linear slope; and estimating the plurality of slopes as a plurality of model parameters in a nonlinear Kalman filter applied to the data.

In another aspect, an apparatus is provided including a processor to process bathymetric data, wherein the processor is configured to: iteratively fitting data obtained by an underwater sensor from interactions between acoustic signals and an underwater floor; and deriving at least one of motion, position, or navigation data of the underwater sensor from said fitting. In one embodiment, the processor is configured to derive at least one of motion, position, or navigation data without input from any motion or position sensor.

In another aspect, a system is provided including a transducer array to transmit acoustic signals underwater to interact with an underwater floor; and a processor to process data obtained from interactions between the acoustic signals and the underwater floor, wherein the processor is configured to: iteratively fitting data obtained by an underwater sensor from interactions between acoustic signals and an underwater floor; and deriving at least one of motion, position, or navigation data of the underwater sensor from said fitting. The system can be a standalone system without a motion or position sensor.

In another aspect, a non-transitory computer readable medium is provided having instructions stored thereon, wherein the instructions include: iteratively fitting data obtained by an underwater sensor from interactions between acoustic signals and an underwater floor; and deriving at least one of motion, position, or navigation data of the underwater sensor from said fitting.

In some embodiments, the fitting includes removing data having a deviation higher than a first threshold from a first polynomial; fitting remaining data to a second polynomial; reducing the first threshold to a second threshold; and removing data having a deviation higher than the second threshold from the second polynomial. The first and second polynomials can be obtained from least-square fitting. The iteratively fitting data can include iteratively fitting the data obtained from a single discrete transmission of the acoustic signals. The data can be obtained from multiple discrete transmissions of the acoustic signals, and the instructions can further include determining whether the data are sufficient for statistics over the multiple discrete transmissions.

In some embodiments, the instructions further include applying a Bayesian statistics to the data obtained from multiple discrete transmissions. The application of Bayesian statistics can include applying a recursive filter. The recursive filter can include a Kalman filter. The application of the Kalman filter can include: initializing the filter; generating a prior density; generating a posterior; incrementing a time index; and returning to said generating a prior density.

In an embodiment, the Kalman filter includes an Unscented Kalman Filter. The application of the Unscented Kalman Filter can include deterministically calculating a set of weighted sigma points using a mean and square-root decomposition of a covariance matrix constructed from the data; propagating the set of weighted sigma points through a true nonlinear function using a functional evaluation to generate a posterior sigma point set; and approximating posterior statistics using tractable functions of the posteriori signal point set.

In some embodiments, the instructions can further include providing at least one of a dynamic model of the motion of the sensor or a dynamic model of the underwater floor variation. The derived motion, position, or navigation data can include: a first component from the motion of the sensor; and a second component from the underwater floor variations.

In an embodiment, the instructions further include separating the first and second components from the data.

In some embodiments, the instructions further include obtaining the motion data of the sensor from the first component. The motion can include a heave motion, and wherein the second component comprises a multiplicative component introduced by a slope of the underwater floor to the first component, the method further comprising removing the multiplicative component. The motion can include a roll motion, and wherein the second component comprises an additive component introduced by a slope of the underwater floor to the first component, the method further comprising removing the additive component.

In some embodiments, the deriving is performed without a motion or position sensor. The motion data can include at least one of a roll motion or a heave motion.

In some embodiments, the instructions further include applying spectrum filtering to the derived motion, position, or navigation data for underwater floor variations. The application of spectrum filtering can include applying a low-pass filter.

In some embodiments, the instructions further include performing a joint state-parameter estimation over the data to separate a bias in the data introduced by the underwater floor variation.

The instructions can further include dividing a track in the underwater floor into a plurality of segments each having a substantially linear slope; and estimating the plurality of slopes as a plurality of model parameters in a nonlinear Kalman filter applied to the data.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 illustrates an underwater vehicle having a sonar therein for sending acoustic signals toward a seafloor.

FIG. 2 illustrates an interferometer configuration of a sonar where the elevation angle of a reflecting source on the seafloor can be obtained from the phase difference between signals received by multiple transducer elements of the transducer array.

FIG. 3 illustrates a sensor configuration used for deriving a roll motion of the sensor.

FIG. 4 is a plot of example bathymetry data from which the sensor roll motion can be derived.

FIG. 5 illustrates the derivation of the roll motion when the seafloor is sloped.

FIG. 6 illustrates the derivation of the roll motion when the seafloor is arbitrarily curved.

FIG. 7 illustrates the derivation of the geometry of sensor pitch using altitude measurements.

FIG. 8 illustrates that both pitch and heave alter sensor depth calculation from ping to ping.

FIG. 9 illustrates that across-track slope of seafloor terrain results in a scale bias to sensor depth calculation, and the scale bias introduces a multiplicative stochastic spectrum shift in heave computation.

FIG. 10 is a flowchart illustrating a method of obtaining motion data from bathymetry measurements.

FIG. 11 is a block diagram of an example computer program.

FIG. 12 illustrates an example iterative polynomial data fitting process.

FIG. 13 illustrates an example estimation of heave from altitude data.

FIG. 14 illustrates a dynamic system with hidden state variables X that are observable via output measurements Z.

FIG. 15 illustrates selection of sigma points for the Unscented Kalman Filter algorithm using a 2D random variable example. The five sigma points are represented by the distribution mean and four points of the square root decomposition of the covariance matrix (two on each axis, one sigma away from the mean).

FIG. 16 illustrates estimated roll angles from one example data set.

FIG. 17 illustrates estimated depths from the data set.

FIG. 18 illustrates one embodiment where the cross track is split into regions sufficiently narrow to be approximately flat, and the apparent depth of every region is estimated.

FIG. 19(a) illustrates the estimated and measured (ground truth) roll trajectory curves for an example data file.

FIG. 19(b) is a blow-up view of a segment of the curves in FIG. 19(a).

FIG. 20(a) illustrates sonar image of the data file pipe3turns25m.k8e, showing a pipe (the sensor moves in a zigzag fashion along the pipe).

FIG. 20(b) illustrates motion-corrected bathymetry data obtained from the same data file at ping 2000, showing strong nonlinear surface depth across track.

FIG. 21(a) illustrates roll estimate results after bandpass filtering, where the low frequency is filtered out, while the ground truth data contains low-frequency components.

FIG. 21(b) illustrates that adding the missing low-frequency signal to the estimation motion improves the estimation accuracy.

FIG. 22(a) illustrates that low-frequency motion components still exist in bandpass-filtered heave estimation.

FIG. 22(b) illustrates that adding the low frequency component back reduces error from 30.2% to 10.4%.

FIG. 23(a) illustrates the estimated (after a correction for a constant offset) and measured (using Octans) heave trajectory curves from the data file line1.k8e.

FIG. 23(b) is a blow-up view of a segment of the curves in FIG. 23(a).

FIG. 24 illustrates the bounds of the point-wise range error on sampling frequency.

FIG. 25 illustrates a flowchart of the simulation process for motion estimation performance.

FIG. 26 illustrates a comparison of predicted and actual roll estimation errors.

FIG. 27 illustrates a comparison of predicted and actual heave estimation errors.

FIG. 28(a) illustrates an amplitude intensity image, showing significant variations from ping to ping in data file line1.k8e from Dataset Nov16.

FIG. 28(b) illustrates the median amplitude per ping.

FIG. 29(a) is an (x, z) plot of all data points at ping 200 from the line1.k8e data file, illustrating the removal of outliers in bathymetry data.

FIG. 29(b) is an (x, z) plot with data points of amplitudes>1000.

FIG. 30(a) illustrates that the roll estimation error decreases as the amplitude threshold increases (dashed line), where the mean values of absolute differences are plotted from the data file line3.k8e.

FIG. 30(b) is a plot of standard deviations of the absolute differences.

FIG. 31(a) illustrates estimated roll angles from the data file rocks125m.k8e, which contain low-frequency components resulting from the cross-track slope variation.

FIG. 31(b) illustrates the low-pass filtered estimated roll angles, where the artifacts caused by the slope variation are removed and the accuracy is substantially improved.

FIG. 32(a) illustrates a plot of motioned-corrected (x, z) data, where a slope is present at one side and the other side of the surface is flat at the other.

FIG. 32(b) illustrates data from another side showing a bowl-shaped seafloor surface.

FIG. 33 illustrates a plot of surface roughness along track for the data file line1.k8e (top panel), a plot of absolute roll estimation error (middle panel), and a plot of absolute heave estimation error (bottom panel).

FIG. 34 illustrates a plot of surface roughness along track for the data file rocks125m.k8e (top panel), a plot of absolute roll estimation error (middle panel), and a plot of absolute heave estimation error (bottom panel).

### DETAILED DESCRIPTION

Following below are more detailed descriptions of various concepts related to, and embodiments of, inventive methods and apparatus for deriving motion, position, or navigation data from bathymetry data. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

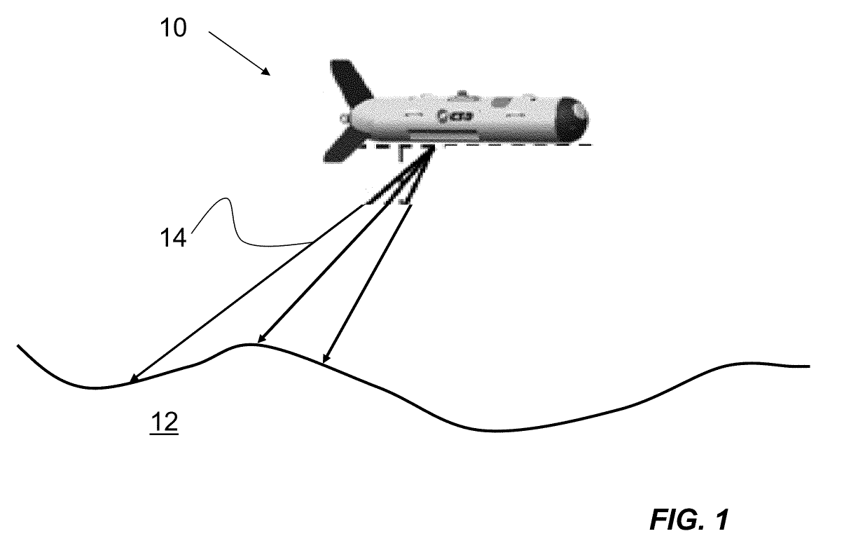

As illustrated in FIG. 1, underwater vehicle 10 can use its onboard sonar to take images of floor 12 target area. The sonar can operate as an imaging interferometer. The sonar uses, for example, 3 MHz ultrasonic acoustic signals, and operates either monostatically (in a pulse-echo mode) or bi-statically (with a separate transmitter), to produce data related to the floor 12. If the data is about the underwater depth of the lake or ocean floors, the data are referred to as bathymetry data. The bathymetry data can be further divided into depth countours or isobaths, or selected depths referred to as soundings.

Modern sonars can also take three-dimensional volumetric images of the floor 12. The images can be taken at a frame rate of, for example, 15 frames/second.

The ultrasonic acoustic signals are transmitted from the sonar as discrete pulses (i.e., pings) 14 toward the floor 12. Multiple beams can be used, and are arranged in a fan-like swath having an angular span of, for example, 90°-170°.

A controller can be included onboard the underwater vehicle 10. The controller can be implemented, for example, with a processor for analyzing images, memory for storing images and related information, an input/output interface for transmitting analysis results or imaging data to a surface-based computer.

A communication link (e.g., cable) can be provided for transmitting image and other data to a surface-based operation center, as well as sending communications from the operation center to the underwater vehicle 10. Location parameters associated with the image data may be included with the image data (e.g., based on predefined coordinates). Alternatively, such location parameters can be associated with the image data at the operation center.

The underwater vehicle is subject to six degrees of freedom motions: heave (up and down), sway (left and right), surge (forward and backward), pitch (tilting forward and backward), yaw (turning left and right), and roll (tilting side to side). Depending on whether the underwater vehicle 10 is autonomous, towed by a cable from a boat, or affixed to the hull of the boat or affixed to a rigid rod, the motions of the underwater vehicle 10 may be coupled to the motions of the boat.

Heave motion introduces an actual change of depth from the sensor to the seafloor surface, and often affects the bathymetry data more than the other motions.

Traditionally, the data collected with bathymetry sensors contain artifacts resulting from the sensor's motion during data collection. These artifacts due to sensor motion are generally considered undesirable. Thus, a conventional sonar system also collects motion data to apply a correction to the bathymetry data to correct for the motion artifact. The motion data are collected, for example, using a dedicated motion sensor that is based on an inertial navigation system (INS), a global positioning system (GPS), or a combination thereof. Thus, the sonar system can include the dedicated motion sensor integrated with the acoustic sensor. A dedicated high-resolution motion sensor is used to correct for artifacts resulting from the motions of the underwater vehicle. The dedicated motion sensor contributes to a significant percentage of the overall cost for a conventional bathymetry sensing system.

A patch test is conducted with the integrated system to eliminate any angular offsets between the acoustic sensor and the motion sensor. This is used because the wide data swath makes data acquisition very sensitive to roll errors because the width of the swath is effectively a lever arm that magnifies roll errors in the final data set.

As one example of an underwater vehicle or platform of a sonar system disclosed herein, the Benthos C3D is an off-the-shelf acoustic technology available for hydrographic survey applications. C3D uses a single acoustic source and an array of N=6 receiver elements stacked vertically to generate both bathymetry and sonar imagery. Although C3D data does have a nadir gap, it provides co-located bathymetry and imagery data in a single towed sensor at sidescan swath widths, that is, C3D provides bathymetry and imagery data swaths at 10× the sensor height above bottom per side. C3D utilizes a technique called Computed Angle of Arrival Transient Imaging (CAATI). The array can resolve N−1=5 simultaneous angles of arrival, providing results that have advantages over both interferometric sidescan sonar and multibeam echosounders. C3D data is logged in Teledyne Benthos .k8e format independent of 3rd party data acquisition software.

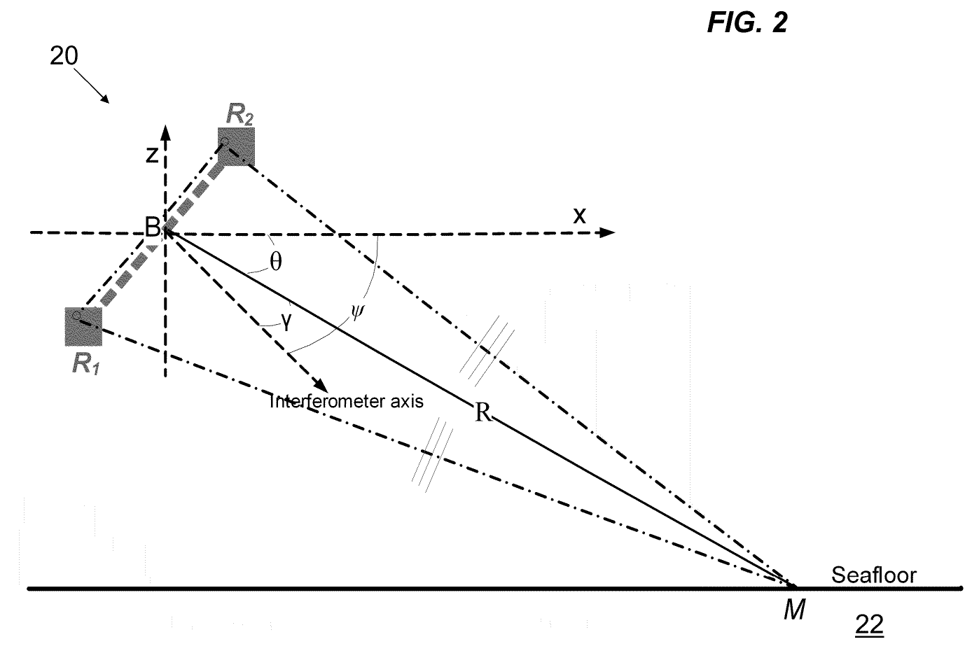

As illustrated in FIG. 2, the sonar 20 can be considered an extension of a traditional two-element interferometer. The elevation angle of a reflecting source on the seafloor 22 can be recovered from the phase difference between signals received by multiple transducer elements of the transducer array.

In one example, the sonar 20 uses a six-receiver configuration. Nevertheless, the bathymetry principle is similar to a two-receiver configuration. The interferometry principle can be explained using a two-receiver interferometer configuration. The interferometer axis has a tilt angle φ=φ₀+φᵣ with respect to the horizontal axis as shown in FIG. 2, where φ₀ is the operating declination angle of the transducer array and φᵣ is the array tilt resulting from a sensor roll motion. In one embodiment, the receiver array is substantially vertical, i.e., φ₀˜0°.

The acoustic echo from a point Mon the seafloor 22 reaches both receivers R₁ and R₂. Let θ be the elevation angle of M with respect to the sensor, the phase difference between the signals received by the two receivers can be expressed as:

$$Δ {φ}_{{R}_{1} , {R}_{2}} = \frac{2 π Δ R}{λ} = \frac{2 π}{λ} B sin ( γ ) = \frac{2 π}{λ} B sin ( ψ - θ )$$

$$where$$

$$λ = \frac{c}{{f}_{c}} ,$$

c is the speed of sound, f_{c} is the operating frequency of the transmitted pulse, ΔR== M̅R̅₂̅− M̅R̅₁̅ is the path length difference between the two receivers to M, and B is the spacing between the two receivers.

γ=φ−θ is the angle of point M with respect to the interferometer axis. This angle, referred to as the apparent elevation angle, is the combined result of the true elevation angle of M and the tilt angle of the interferometer 20. By measuring the phase difference between the two transducer elements Δφ_{R}_{₁}_{,R}_{₂}, the interferometer 20 can measure γ as:

$$γ ≡ {θ}_{a} = {sin}^{- 1} ( \frac{c Δ {φ}_{{R}_{1} , {R}_{2}}}{2 π {f}_{c} B} ) \qquad ( 1 )$$

### Roll Motion Estimation

In accordance with embodiments disclosed herein, motion estimation can be obtained (recovered) based on the relationship of sensor motion and the observed bathymetry data triplets: θₐ, r, a), where θₐ is the apparent elevation angle, r is the echo range, and a is the echo amplitude. In some situations sensor motion within each ping can be assumed to be negligible. For roll motion estimation the sensor array declination angle φ₀ is assumed to be known. Recovery of roll angle is calculated by first obtaining the overall tilt angle φ of the interferometer axis, and then subtracting the declination angle φ₀.

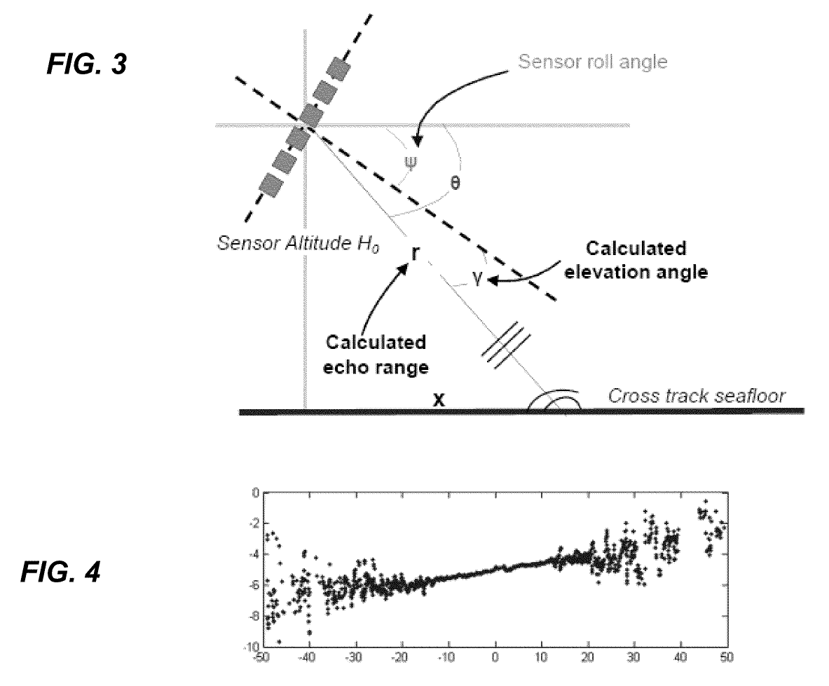

FIG. 3 illustrates a six-receiver interferometer configuration used for deriving a roll motion of the sensor. As discussed above, the motion of the interferometer alters the interferometer's reference axis with respect to the ocean surface coordinates. For example, if six-receiver array is initially set to be substantially vertical to the ocean surface, a roll motion caused by the ocean wave would tilt the array, causing a misalignment with the ocean coordinate system. This misalignment introduces changes to the bathymetry calculation. This is normally undesirable to bathymetry measurements, but can be exploited to derive the causing motion without a dedicated motion or position detector.

If the seafloor is level across each swath, and H₀ is the depth from the sensor to the seafloor at a given ping, let {(θ_{a,j}rᵢ)|i=1, 2, . . . , M} be the measured apparent elevation angles and ranges from M data sources across track, it can be obtained that

\hat{z}ᵢ=rᵢ sin θ_{a,i}=rᵢ(φ−θᵢ)=rᵢ sin φ cos θᵢ=rᵢ sin θᵢ cos φ=xᵢ sin φ−H₀ cos φ

\hat{x}ᵢ=rᵢ cos θ_{a,i}=rᵢ cos(φ−θᵢ)=rᵢ cos θᵢ cos φ+rᵢ sin θᵢ sin φ=H₀ sin φ (2)

where xᵢ is the cross-track position of echo source Mᵢ. From Eq. (2), it can be obtained that:

d\hat{z}ᵢ/d\hat{x}ᵢ=tan(φ).

In other words, data points (\hat{x}ᵢ, \hat{z}ᵢ) form a linear relationship. Consequently, the tilt angle of the interferometer axis may be estimated from the slope of {(\hat{x}ᵢ, \hat{z}ᵢ)|i=1, 2, . . . , M} using a linear least-squares minimization scheme:

$$( {m}^{*} , {b}^{*} ) = arg {min}_{m , b} {( {\hat{z}}_{l} - m {\hat{x}}_{l} - b )}^{2} \\ \hat{ψ} = {tan}^{- 1} ( {m}^{*} ) \\ {\hat{ψ}}_{r} = \hat{ψ} - {ψ}_{0} \qquad ( 3 )$$

FIG. 4 is a plot of example bathymetry data from which the sensor roll motion can be derived.

Furthermore, it can be shown that the estimated constant term b* is related to the water-column depth from the sensor as:

H₀=b* cos φ (4)

If the seafloor has a linear slope across track, with slope s=tan(Θ), where Θ is the slope angle, then the depth from the sensor to the seafloor is a linear function of the lateral distance across track:

H(x)=H₀−tan(Θ)x

Consequently, Eq. (2) becomes:

\hat{z}ᵢ=xᵢ sin φ−H(xᵢ)cos φ=xᵢ sin φ−(H₀−xᵢ tan(Θ))cos φ

\hat{x}ᵢ=xᵢ cos φ+H(xᵢ)sin φ=xᵢ cos φ+(H₀−xᵢ tan(Θ))sin φ

The slope of the observed depth measurements cross track is therefore the sum of the roll angle and the angle of the surface slope:

d\hat{z}ᵢ/d\hat{x}ᵢ=tan(φ+Θ)

H₀=b*cos(φ+/Θ)/cos Θ (5)

From Eq. (5) it can be seen that an unknown linearly sloped seafloor surface across-track at a ping introduces an additive bias in the roll angle computation in the least-squares linear fitting in Eq. (3) and a multiplicative bias to water-column depth, which in turn induces a multiplicative bias to the heave computation. This bias may vary from ping to ping if the slope changes along track.

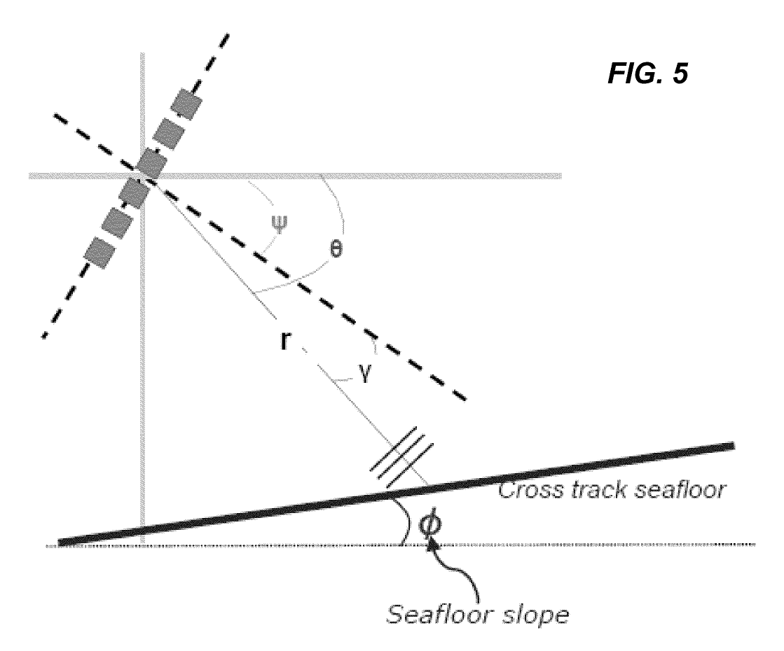

FIG. 5 illustrates the derivation of the roll motion when the seafloor is sloped. The slope angle component may be eliminated from motion estimation based on the assumption that at a sufficient sensor altitude, the seafloor terrain varies slower than the roll motion. Thus, the spectral difference between the seafloor slope and the roll motion can be used to remove the slope angle component.

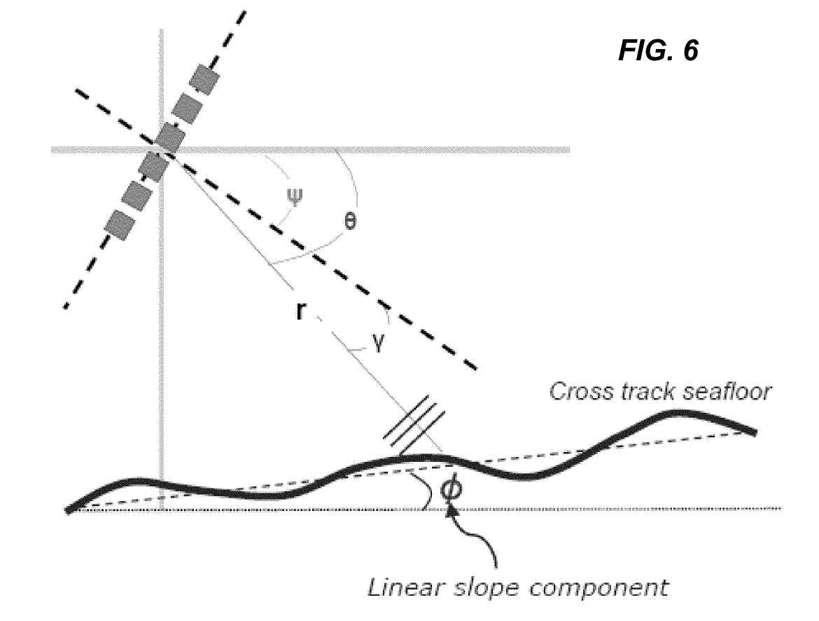

The seafloor in general will not be completely linear or level across track. FIG. 6 illustrates the derivation of the roll motion when the seafloor is arbitrarily curved. If the seafloor surface has a higher-order curvature across the track, the seafloor surface depth can be approximated as a random polynomial of k-th order:

H(x)=pₖ(x)+nₕ

pₖ(x)=h₀+h₁x+ . . . +hₖx^{k}

nₕ˜random roughness fluctuation (6)

The relationship between \hat{x}ᵢ and \hat{z}ᵢ obtained from such a non-linear surface depth is complex and nonlinear. To deal with such non-linearity of data points (\hat{x}ᵢ, \hat{z}ᵢ) in roll computation, a least-square fitting of {(\hat{x}ᵢ, \hat{z}ᵢ)|i=1, 2, . . . , M} is applied with a polynomial of nth-order. The coefficient of the first-order term in the polynomial is used to estimate the roll motion:

(q₀*,q₁*, . . . ,qₙ*)=arg min(\hat{z}ᵢ−qₙ(\hat{x}ᵢ))²

\hat{φ}=tan ⁻¹(q₁*)^{q}^{ₒ}^{,q}^{₁}^{, . . . q}^{ₙ}

\hat{φ}ᵣ=\hat{φ}−φ₀

The coefficient of the first-order term in the polynomial fitting corresponds to the derivative of the first order. From Eq. (6) it can be shown that the first derivative is:

$$\frac{d \hat{z}}{d \hat{x}} {\vert}_{\hat{x} = {\hat{x}}_{i}} = \frac{sin ψ - {p}_{k}^{′} ( {\hat{x}}_{i} ) cos ψ}{cos ψ + {p}_{k}^{′} ( {\hat{x}}_{i} ) sin ψ}$$

For a small roll motion, sin φ≈0, and it can be seen that the derivative of first order of data points {(\hat{x}ᵢ, \hat{z}ᵢ)|i=1, 2, . . . M} approximately is the sum of a constant sum of the true roll angle and the linear slope and a high order polynomial term:

d\hat{z}ᵢ/d\hat{x}ᵢ≈ tan(φ+Θ)+Qₖ₋₁(x)

From the above equation, it can be seen that for a curved seafloor, the least-squares polynomial fitting method for roll estimate will be contaminated by a term that is proportional to the rate of non-linear variation of the seafloor surface. That is, if the roll motion is small, the slope of echo depths contains an additive high-order term related to the non-linear seafloor surface variation.

Eliminating this high-order contamination from the roll computation may be difficult for arbitrary surfaces. If the seafloor surface is slow-varying along-track, this bias can be reduced via a spectrum filtering post-processing over the estimated roll trajectory along track.

Pitch and Heave Motion Estimation

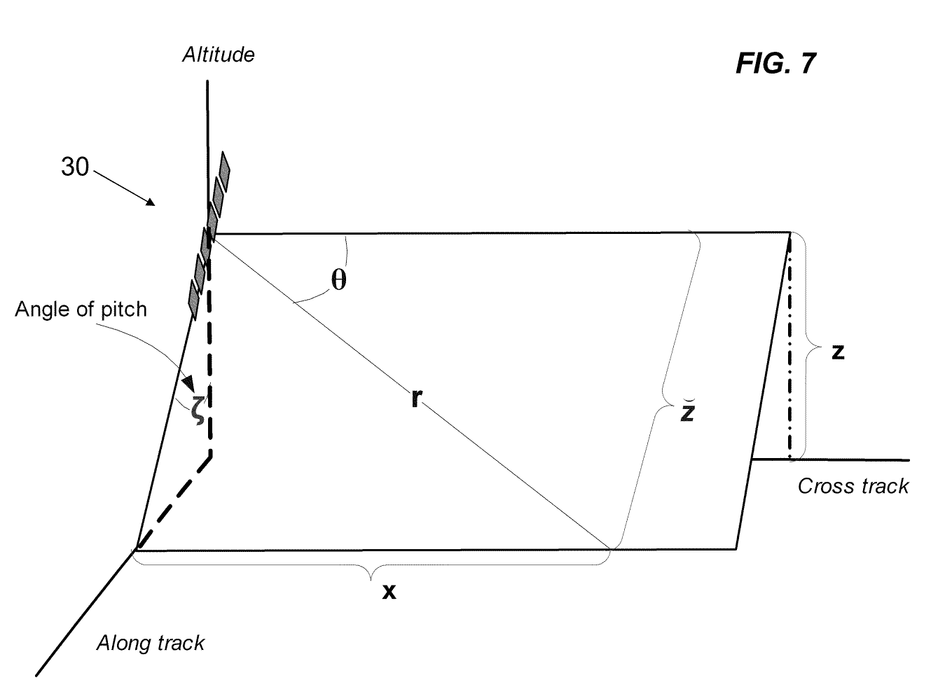

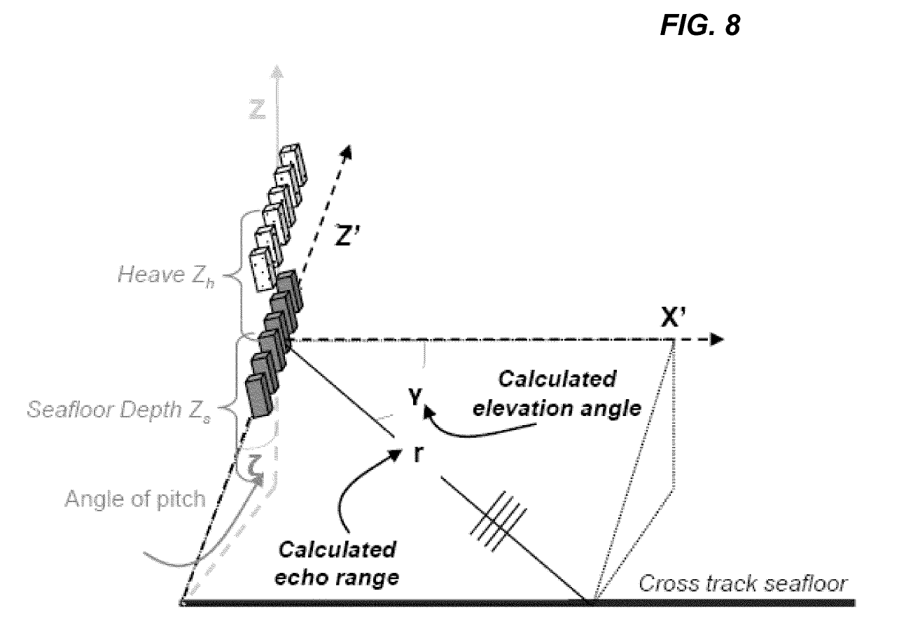

In the following, the recovery of pitch motion data according to one embodiment is described. As illustrated in FIG. 7, pitch causes a deviation to the depth measurement in the bathymetry data. As further illustrated in FIG. 8, both pitch and heave alter sensor depth calculation from ping to ping. If pitch is known, heave can be recovered by nulling-out the frequencies around zero in derived sensor depth along pings.

Assuming that roll motion has been corrected, the relationship between the true depth z of a point on a flat seafloor with respect to the sensor and the apparent depth \check{z} computed from the measured elevation angle θ from an interferometer with a pitch angle ζ is:

zᵢ=\check{z}ᵢ cos ζ

Consequently, if the true depth to a point on the seafloor is known, the pitch angle of the sensor at a given ping may be estimated as the ratio between the true depth and the apparent depth computed from the observed bathymetry data.

When the seafloor is flat across track and its depth z=H₀ is known, the depth estimate from Eq. (4) can be used to estimate pitch:

\overline{\check{z}}ᵢ=b*cos(φ)

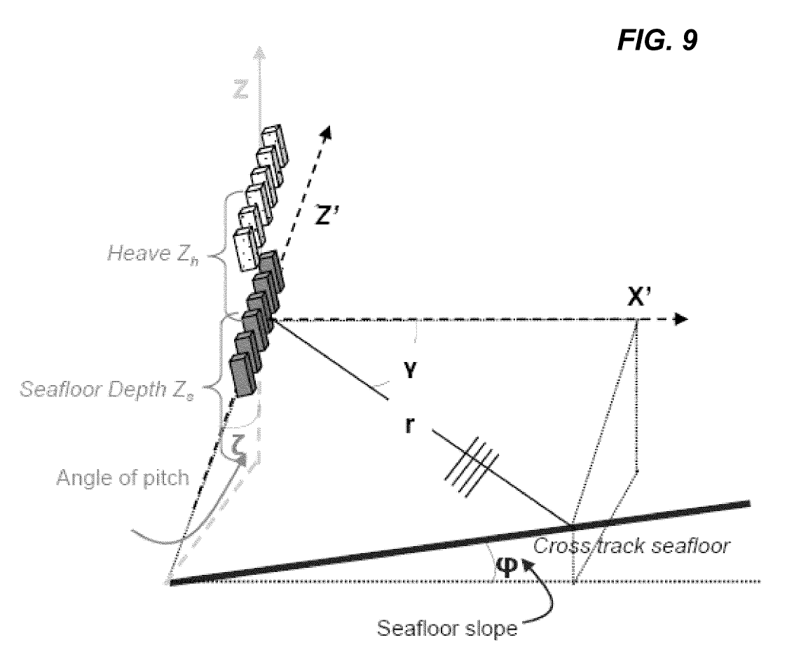

ζ=cos ⁻¹(H₀/ \overline{\check{z}})

[symbol] r a non-flat seafloor, as illustrated in FIG. 9, the depth from the sensor to a data point for a given ping varies along track: zᵢ=H(xᵢ). Thus, pitch should be estimated from individual bathymetry data:

\overline{\check{z}}ᵢ=b*cos(φ)

ζ=cos⁻¹(H₀/ \overline{\check{z}})

[symbol] the roll motion correction is based on estimated roll angle, the bias in the roll angle estimation due to the linear slope angle Θ of the seafloor as well as higher order seafloor surface variations will result in inaccuracy in the computation of \check{z}ᵢ.

The seafloor surface may be assumed flat across track with respect to a reference level z₀ (e.g., the sensor position of the first ping). The depth from the sensor to seafloor surface at ping position j can be written as zⱼ=z_{h,j}+z_{z,j}+z₀, where z_{h,j} is the heave resulting from sensor vertical movement at ping position j and z_{s,j} is the depth change of the seafloor at ping position j, both with respect to z₀. The pitch angle at ping position j can be denoted as ζⱼ. The relationship between the apparent depth \check{z} and that computed from the measured bathymetry (zⱼ)is:

zⱼ=\check{z}ⱼ cos ζⱼ=z_{h,j}+z_{s,j}+z₀ (7)

Equation (7) shows that the apparent depth from bathymetry data contains the combined effect of heave and seafloor depth variation. Given sufficient depth from the sensor to the seafloor it may be assumed that the seafloor surface varies much more slowly relative to the variation of the ocean waves. Consequently, the spectrum of seafloor surface depth variation has a lower frequency signature than that of the heave motion. In one embodiment, a band-pass filter can be used to recover the heave motion.

To extract the heave components z_{h,j} assumptions on the spectrum characteristics of the two components may need to be made. Heave motion and seafloor terrain surface variation result from two unrelated physical processes. Heave is the result of the motion of the air/sea interface and, as a result, its frequency characteristics are constrained by the physics of the waves. It can be assumed that the seafloor surface varies much more slowly compared with the variation of the ocean waves. Consequently, the spectrum of seafloor surface depth variation has a lower-frequency signature compared with that of the heave motion. In one example, a band-pass filter can be used to recover z_{h,j} via a proper choice of cut-off frequencies that differentiates the spectrum of the heave motion from the spectrum of the time-varying change in the seafloor altitude.

Pitch and heave motions introduce variation to the derived depth from the bathymetry data. The values of the two motions are related to the observed bathymetry data as:

\check{z}ⱼ=(z_{h,j}+z_{s,j}+z₀)/cos ζⱼ (8)

There are 3 unknowns, z_{h,j}, z_{s,j}, ζⱼ and one observation \check{z}ⱼ in Eq. (8). Consequently, pitch, heave, and seafloor depth cannot be simultaneously obtained from the observed bathymetry data. Even if the slow-varying seafloor depth variation can be removed via spectrum filtering, the remaining pitch and heave motions are still tightly coupled. It may be difficult to separate the remaining pitch and heave motions as both motions are related to the same physical process and thus can be closely correlated. However, the change in the measured depth as a result of variations in pitch is very small, and in most survey conditions this term may be negligible, or beyond the resolution of the sensor to actually measure.

When the sensor altitude to the seafloor is relatively high, an approximately flat seafloor can be assumed. For such conditions, no perceptible change in the bathymetry data exists as a result of yaw, surge and sway. Some information regarding yaw and sway may exist, but only under contrived conditions such as when collecting data along a straight pipe.

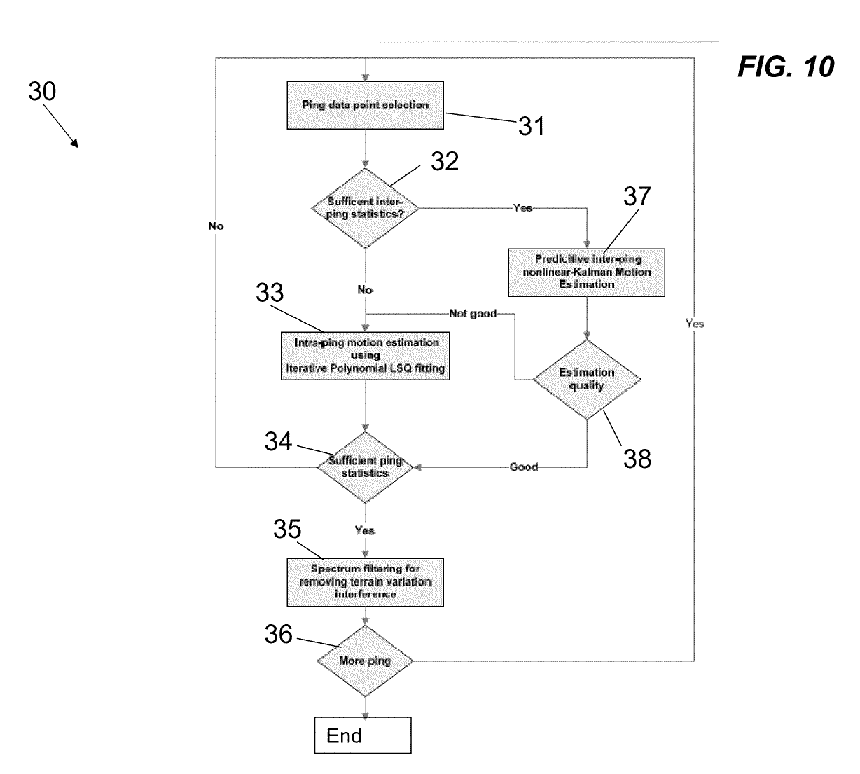

FIG. 10 is a flowchart summarizing an example method 30 of obtaining motion data from bathymetry measurements. In operation 31, data points for one or more pings are selected. In operation 32, it is determined whether there are sufficient data for inter-ping statistics. Initially during measurements, often the data are not sufficient for inter-ping statistics. Consequently, in operation 33 an intra-ping motion estimation is performed using iterative polynomial least-squares (LSQ) fitting. Bathymetric data are often very noisy and contain a significant amount of outliers. The iterative polynomial fitting scheme can reduce influence of outliers in intra-ping motion estimation.

In operation 34, it is further determined whether there are sufficient data from the ping for a statistical spectrum analysis. If yes, in operation 35, spectrum filtering is performed to remove features in the data caused by the seafloor terrain variation. In operation 36, if it is determined that more pings are obtained, the system returns to operation 31.

If in operation 32 it is determined that there are sufficient data from multiple pings for inter-ping statistics, a predictive inter-ping motion estimation can be performed in operation 37, using Bayesian statistics. Such a predictive estimation can be realized by modeling an underlying dynamic model of the sensor motion and/or the underwater floor variation. In some embodiments, a recursive filter is applied to the data from multiple pings. Such a recursive filter can be, for example, a nonlinear Kalman filter. Other recursive filters that may be used may include Bene\check{s} filters, Daum filters, particle filters, and their extensions. The nonlinear Kalman filter technique incorporates constraints of the motion dynamics across pings, and thus improves robustness in the estimation.

In operation 38, it is determined whether the inter-ping motion estimation has a good quality. If yes, then the system turns to operation 34. If not, the system reverses back to the intra-ping motion estimation in operation 33.

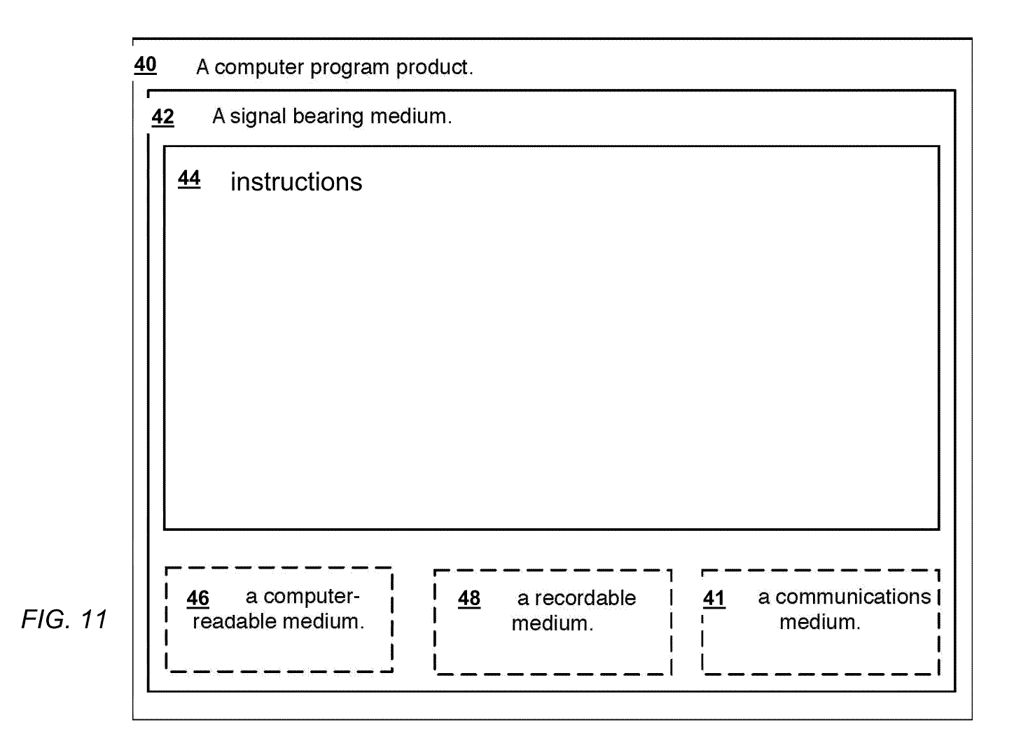

FIG. 11 is a block diagram illustrating an example computer program product 40 for use with the apparatus 20 and implementing the methods described above. The computer program product 40 can include a signal bearing medium 42, which can include a non-transitory computer readable medium 46, such as, but not limited to, a hard disk drive, a Compact Disc (CD), a Digital Video Disk (DVD), a digital tape, memory, etc. The computer program product 400 may also include a recordable medium 48, such as, but not limited to, memory, read/write (R/W) CDs, R/W DVDs, etc. In some implementations, the signal bearing medium 42 may encompass a communications medium 41, such as, but not limited to, a digital and/or an analog communication medium (e.g., a fiber optic cable, a waveguide, a wired communications link, a wireless communication link, etc.). Instructions 44 are stored in the signal bearing medium 42 to perform the data analysis methods as described above.

Working Examples

The example analyses described below are based on four data sets collected in the ocean. Each data set includes bathymetry data of multiple runs of the Benthos C3D swath bathymetry sonar. Each data set includes a variety of seafloor topographies that allow variations in the seafloor to be considered in evaluating the extraction process.

For data collection processes, the C3D sonar was pole-mounted to a 43′ vessel configured for survey operations. The motion it experienced was directly correlated with the movement of the vessel, and thus with the influence of the surface waves on the vessel. In operation, the transducer arrays on both side of the sensor have a declination angle with respect to the sea level (30° for the first data collection and 40° for the remaining collections). The bathymetry software of the sensor automatically corrects for this declination angle when producing the angle/range solutions.

The sea state was minimal when the data sets were collected. Consequently, the motion experience by the sensor was relatively small, providing the best possible approximation of UUV motion.

Motion data were directly collected with the Ixsea Octans Model 1000 motion reference unit to compare with those recovered from the bathymetry data. The Octans is a fiber-optic gyrometer and a gyrocompass and provides precision heading, roll, pitch, yaw, heave, surge, and sway measurements. For the test data collected for this study, only roll, pitch and heave were used for comparison. The table below shows the Octans motion sensor accuracy based on the manufacturer's specifications.

Heave, Surge & Sway:

| | |
|---|---|
| Accuracy | 5 cm or 5% (whichever is highest) |
| Resolution | 1 cm |
| Heave motion periods | 0.003 to 100 s (tunable) |

Roll, Pitch & Yaw:

| | |
|---|---|
| Accuracy | 0.01° |
| Range | No limitation |
| Follow-up speed | Up to 500°/s |

In using the Octans motion sensor measurements as reference, a few factors are accounted for to effectively utilize the Octans for ground truth.

Because the Octans sensor was mounted at a location at a distance away from the sonar, offsets resulting from the distance were accounted for in comparing the heave measured by the Octans sensor with the heave experienced by the sonar. These offsets were carefully measured to within 1 cm to minimize the impact of lever arms. Conventional patch test techniques are employed to determine and account for the motion sensor offsets.

Time offset is another potential source of difference. The motion data from Octans sensor is time-stamped at the moment the data is logged by the data acquisition software. There is therefore a delay between the actual time of the motion and the time at which the motion is recorded. This delay causes a fixed offset in time between the sonar ping data motion estimation and the ground truth.

A third source of misalignment is the temporal sampling rate. The Octans motion sensor operates at a higher sampling frequency than the sonar sensor. The *.k8e data output files store the smoothed and sub-sampled versions from Octans sensor's original data. The algorithm that inserts the motion into the *.k8e file performs a linear interpolation of the motion data from the two nearest samples in time to the actual ping time.

Error analysis suggests that bathymetry measurements recorded at nadir and at the range limit are more susceptible to noises. To mitigate the impact of outliers in measured bathymetry data, data points near nadir and near the range limit, and those with weak amplitudes, are excluded from the motion estimation computation. The data selection procedure extracts data points at each ping as follows.

Let xᵢ=rᵢ cos θᵢ be the computed cross-track position of data point pᵢ=(rᵢ, θᵢ, aᵢ) the data point selection procedure chooses data points for motion estimation that satisfy:

{pᵢ|xᵢ⊂[x₀,x₁],aᵢ>a₀}

The optimal choices of (x₀, x₁, a) are dependent on the property of the seafloor, the operating depth and declination angle of the sonar sensor. The typical choices used in the tests are: [x₀,x₁]=[2.5, 10.0]; a₀=1500 for 25 m range data and [x₀, x₁]=[2.5, 20.0]; a₀=1500 for 50 m and 75 m range data.

The high data density of the C3D sonar allows this down-sampling of data without causing data scarcity.

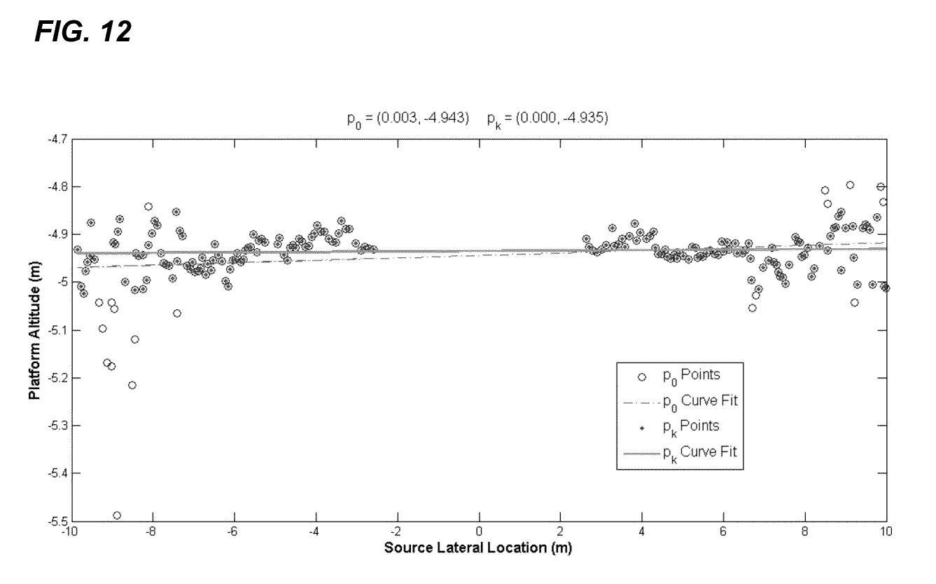

To estimate the platform roll from ping echo data, an iterative polynomial data fitting method is employed, as illustrated in FIG. 12. The coefficients of a first polynomial p₀(x) of degree n that fits the data p₀(x(i)) to z(i) with a least square are first obtained. Once the coefficients are found, the accuracy of the estimated curve against the apparent z values is estimated. Data points located at a distance greater than a predetermined first threshold T are considered outliers, and are removed from subsequent processing.

Next, the data fitting process is repeated using only the (x, z) points that passed the threshold stage to obtain the coefficients for a second polynomial p₁(x). The first threshold can then be tightened using T(n+1)=T(n)×ρ, 0<ρ<1(μ=0.98 in one example) to obtain a second threshold. The polynomial fitting and the outlier removing processes are repeated, until deviations of all surviving data points from the polynomial are within the current threshold.

The iterative process handles outliers in the bathymetry data well. Once the iteration converges, the coefficient of the first-order term of the polynomial pₖ(x) at the end of the iteration is used to define the roll angle of the sonar sensor according to Eq. (3).

A post-processing band-pass filter is applied to the estimated roll curve along-track to reduce the impact of environment changes on roll estimation. The choice of the cut-off frequencies of f_{c}_{_{L}} and f_{c}_{_{H}}, used in the filter will be dependent on the properties of the physical environment in which the sensor operates (e.g., periods of the ocean waves, variation of the seafloor surface). These parameters may be determined empirically in the experiments for each dataset.

The heave estimation algorithm employed according to one embodiment comprises applying two filters over the estimated sensor altitude in Eq. (4):

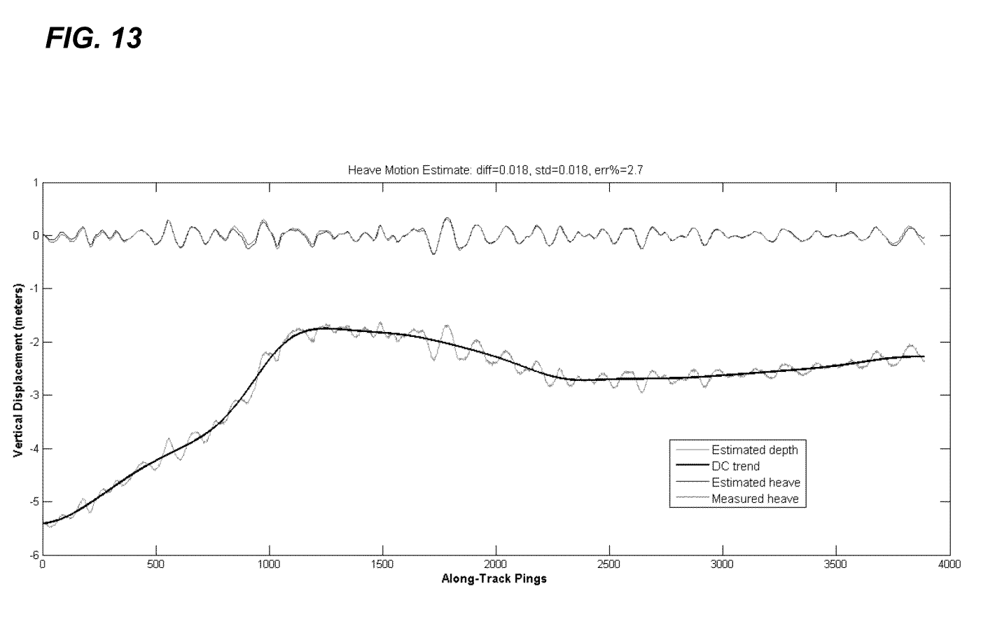

hⱼ=F_{L}(F_{H}(\hat{z}ⱼ)) (9)

where F_{L} is a low-pass filter with a cut-off frequency f that nulls out the frequency around zero in the altitude estimate; F_{H} is a high-pass filter with a cut-off frequency f_{c}_{_{H}} whose purpose is to remove the high-frequency variation due to surface roughness and noise in the computation. In one embodiment, 3^{rd} order butterworth filters are used for both low and high pass filters. FIG. 13 illustrates an example estimation of heave from altitude data.

The choice of f_{c}_{_{L}} and f_{c}_{_{H}} may depend on the properties of the physical environment in which the sensor operates, and can be set empirically. Estimating the sensor altitude using Eq. (9) may require knowledge of sensor pitch angle at each ping. In the example results described below, the pitch readings from the Octans motion sensor are used as the surrogate for estimation of pitch angles. Thus, the accuracy of the heave estimate can be an upper bound of what is actually achievable. The pitch motion in the four datasets is very small. Consequently, the impact of pitch on heave estimation may be negligible.

The least-square fitting-based motion estimation scheme derives motion estimation from data within each ping. Such a single-ping based scheme ignores the correlations of motion between adjacent pings. Furthermore, such a scheme can incorporate neither priori knowledge of the dynamics of ocean waves, nor the dynamics of the seafloor terrain changes into the motion estimation process.

In one embodiment, a Kalman-filter-based motion estimation approach is employed, which allows the incorporation of constrains of the motion dynamics and surface variation dynamics into the motion prediction and estimation model. Such a scheme can potentially provide more accurate motion estimation and be more robust against environmental changes.

The Kalman filter can be used as a recursive solution to the discrete-data linear filtering problem. It provides an optimal recursive algorithm for sequential probabilistic inference under a linear-Gaussian system assumption. Probabilistic inference is the problem of estimating the hidden variables (states or parameters) of a system in an optimal and consistent fashion (using probability theory), given noisy or incomplete observations.

In the case of a time-evolving (dynamic) system, the sequential probabilistic inference problem is to estimate the system state vector xₖ given only measurements zₖ and information of how the system evolves over time and how we observe it. Given linear dynamic system equations:

xₖ=Aₖ₋₁·xₖ₋₁+Bₖ₋₁·uₖ₋₁+vₖ₋₁

zₖ=Hₖ·xₖ+nₖ

where vₖ˜N(0,Q) is a zero-mean Gaussian white process noise, and nₖ˜N(0, R) is a zero-mean Gaussian white observation noise, a Kalman filter generates maximum a posteriori state estimate:

$$\hat{x} = {arg max}_{x} ( {ρ}_{x \vert z} )$$

The algorithm can be summarized as:

1. At k=0: Initialize filter.

State prior: x₀˜ρₓ_{₀}=N(\hat{x}₀, P₀)

Process noise: v₀˜μᵥ_{₀}=N(0,Q)

Measurement noise: n₀˜μₙ_{₀}=N(0,Q)

2. Time Update (generate prior density)

ρxₖ|z_{1:k-1}=N(\hat{x}ₖ⁻,Pₖ⁻) [symbol] \hat{x}ₓ⁻=Aₖ₋₁+Bₖ₋₁uₖ₋₁Pₖ⁻=Aₖ₋₁Pₖ₋₁Aₖ₋₁^{T}+Cₖ₋₁Qₖ₋₁Cₖ₋₁^{T}

3. Measurement Update (generate posterior)

ρₓ_{ₖ}_{|z}_{_{1:k1}}=N(\hat{x}ₖ,Pₖ) [symbol] Kₖ=Pₖ−Hₖ^{T}(HₖPₖ⁻Hₖ^{T}+DₖRₖDₖ^{T})⁻¹\hat{x}ₖ⁻+Kₖ(zₖ−Hₖ\hat{x}ₖ⁻)Pₖ=(I−KₖHₖ)Pₖ⁻

4. Increment discrete time index k . . . Jump to step 2.

It is noted that the Kalman filter may be optimal for linear Gaussian systems. If the Gaussian assumption is relaxed, the Kalman filter can still be an optimal (with minimum error variance) filter out of the class of linear unbiased filters. Time update increases uncertainty, while measurement update decreases uncertainty: Pₖ₊₁⁻>Pₖ, Pₖ₊₁<Pₖ₊₁⁻. Thus, in other words, the Kalman filter works in a predictor/corrector fashion for the unobserved (predicted) system x being corrected with observation z:

\hat{x}ₓ=(predication of xₖ)+(Gainₖ)×[(observation of zₖ)−(prediction of zₖ)]

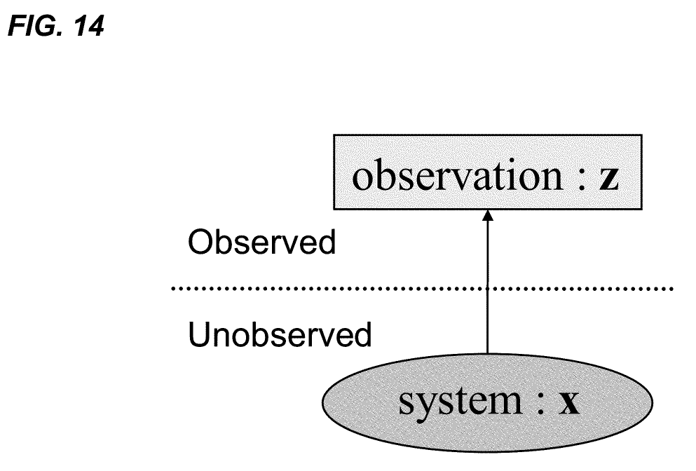

FIG. 14 illustrates a dynamic system with hidden state variables X that are observable via output measurements Z.

The Kalman filter easily allows incorporating colored (time-correlated) noise by expanding the system dynamics to include noise-shaping filters.

In one embodiment, to apply the Kalman filter to the motion estimation problem (roll and heave/depth), a motion dynamic model and a sensor observation model are used. The sensor motion dynamics may be directly correlated with the motion dynamics of the vessel. A state vector can be defined as x=(φ, \check{z})^{T}, based on the roll angle and apparent depth. As discussed above, due to the sensor limitations, the true depth estimate may be contaminated with a component resulting from the pitching motion. Since the boat dynamics is not available at this time, the roll and heave motion may be modeled as driven by a random walk:

xₖ₊₁=xₖ+vₖ

The covariance Q of the white Gaussian process noise vₖ is a diagonal matrix (with the assumption that roll and heave process noises are not correlated), and can correspond to the belief on how much roll and depth/heave are likely to change between measurement samples. Higher process noise means that the state vector can change quickly. Lower process noise will have smoothing effect on the estimate: rapid measurement changes will have smaller effect on estimate as they will be counteracted by the belief that the dynamics are slow.

At each ping, the sonar measurements include two sets of data: port data and starboard data. Each of the data sets includes pairs

$${\{ {θ}_{i}^{port} , {r}_{i}^{port} \}}_{i = 1}^{{N}_{port}} and {\{ {θ}_{i}^{stbd} , {r}_{i}^{stbd} \}}_{i = 1}^{{N}_{stbd}}$$

. The number of pairs in each set varies from ping to ping. Thus, an observation may have variable dimensions. Further complications arise from the fact that observations within each pair are constrained via the state vector and the assumption of the flat sea floor, and these observations are not independent from each other. This means that for each pair, one of the observations is expressed through the other one and the boat state vector. This is not a common situation in the recursive state estimation where observations are typically expressed through the state vector only. To derive an observation model in such a case, one of the observations (range r) in each pair can be treated as a sampling point on the virtual line that represents the sea floor and the other observation (angle θ) as a measurement at that sampling point. The resulting observation model is nonlinear and is based on Eq. (2):

$${θ}_{i , k}^{port} = arcsin ( \frac{{\breve{z}}_{k}}{{r}_{i , k}^{port}} ) + {ψ}_{k} + {n}_{k}^{port} , \qquad i = 1 … {N}_{port}$$

$${θ}_{i , k}^{stbd} = arcsin ( \frac{{\breve{z}}_{k}}{{r}_{i , k}^{stbd}} ) - {ψ}_{k} + {n}_{k}^{stbd} , \qquad j = 1 … {N}_{stbd}$$

Note that the observation noise covariance matrix R is diagonal and has variable dimensions from ping to ping.

Since the observation model is nonlinear, a nonlinear estimation algorithm can be employed. In one embodiment, the Unscented Kalman Filter (UKF) is employed, which uses a propagation different from the standard Extended Kalman Filter (EKF) that is commonly used in nonlinear estimation. The UKF is an extension to the standard Kalman filter. The Unscented Transformation can be summarized by the following three steps, which are referred to as the sigma-point approach for approximating the statistics of a random variable that undergoes a nonlinear transformation:

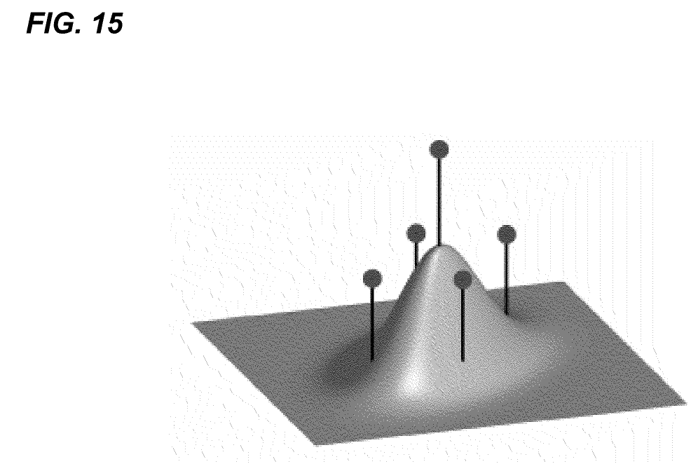

(1) A set of weighted sigma-points are deterministically calculated using the mean and square-root decomposition of the covariance matrix of the prior random variable. The sigma-point set can completely capture the first- and second-order moments of the prior random variable. Higher-order moments can be captured, if so desired, at the cost of using more sigma-points. A second-order example is illustrated in FIG. 15, where weighted sigma-points for a 2-dimensional Gaussian random variable (RV) are shown. These sigma-points lie along the major Eigen-axes of the RV's covariance matrix and completely capture the first- and second-order statistics of the RV. The height of each sigma-point indicates its relative weight.

(2) The sigma-points are then propagated through the true nonlinear function using functional evaluations alone, i.e., no analytical derivatives are used, in order to generate a posterior sigma-point set.

(3) The posterior statistics are calculated (approximated) using tractable functions of the propagated sigma points and weights.

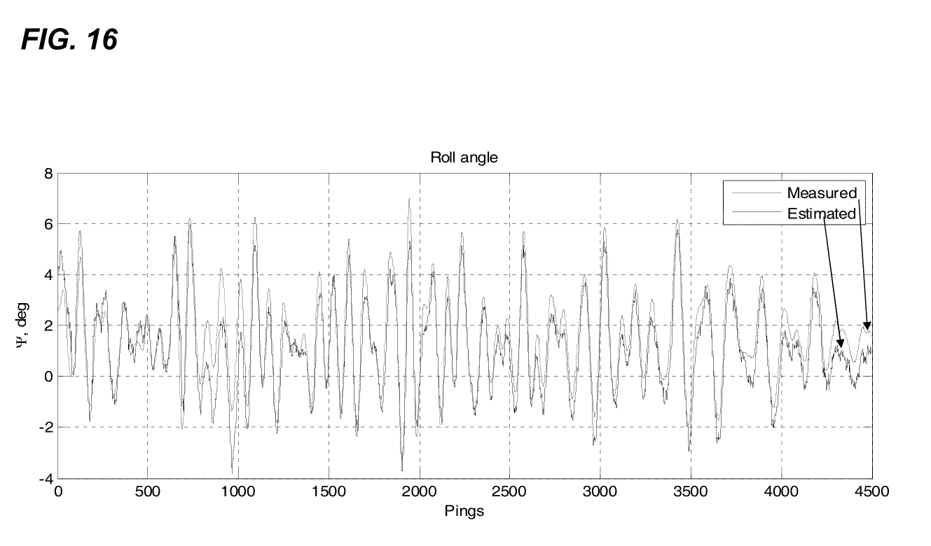

Example of the state estimation for data file line5.k8e is illustrated in FIG. 16 and FIG. 17. Specifically, FIG. 16 illustrates estimated roll angles, and FIG. 17 illustrates estimated depth. Seafloor is assumed flat. Prior to running the UKF, observation data were filtered to exclude measurements with amplitudes below 1000 and ranges below 1 m.

It is noted that the assumption of the seafloor being flat is not a prerequisite for motion estimation purposes. Inclined sea floor will result in a constant or slowly changing bias in the roll angle estimate.

In another embodiment, a low-pass filter is used to separate the true roll from the sea floor inclination. However, simple spectrum filtering may not be able to differentiate low-frequency motion elements from other low-frequency elements caused by environmental changes. As a result, the low-pass filtering can erroneously remove slow-varying motion components from the estimated motion, resulting in a larger estimation error.

An alternative way to separate the true roll angle from the bias introduced by the seafloor inclination is to estimate the bias as a model parameter (joint state-parameter estimation). This would require changing the dynamic model to reflect the fact that average roll is zero over a long interval. Total roll estimate passed through the low-pass filter will yield the sea floor inclination.

A curved seafloor may present problems and significantly degrade estimation quality since the observation model according to one embodiment relies on the assumption that the seafloor has no high-order irregularities. With this observation model, echo signals from curvy or irregular bottom will be inconsistent with the model, and curved seafloor introduces nonlinear distortion to the motion estimation.

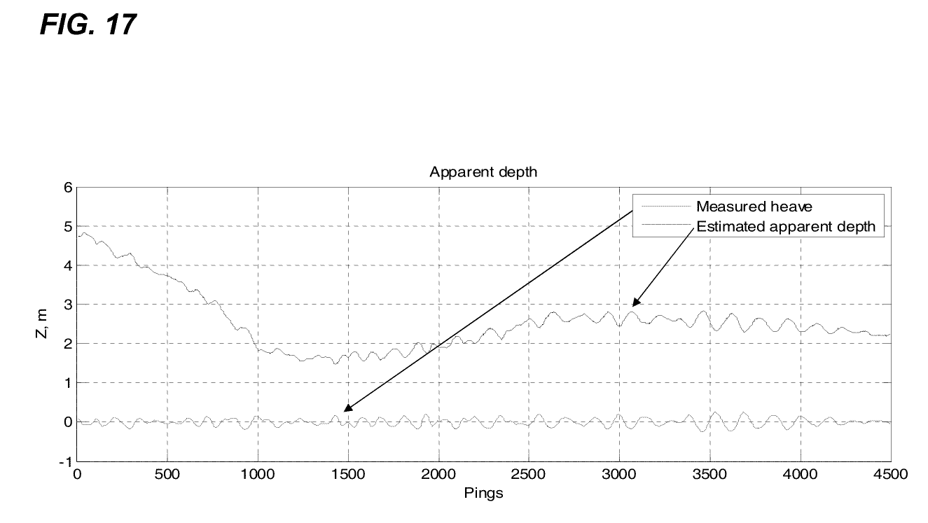

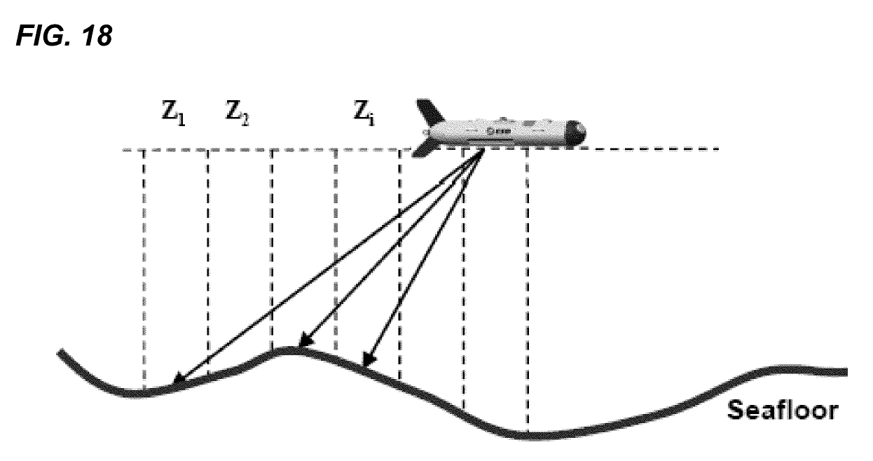

To solve this problem, in one embodiment a joint state-parameter estimation model is adopted and the cross track is split into regions or segments sufficiently narrow to be approximately linear, and the apparent depth of every region is estimated wherein each region is presented by a linear slope (see FIG. 18). The slopes of the linear regions are considered as model parameters, which together with the motions are simultaneously predicted and estimated using a nonlinear Kalman filtering scheme.

In one embodiment, the estimated state vector can be extended to include depths of the regions: x=(φ, \check{z}₁, . . . \check{z}ₙ)^{T}. This approach to some extent resembles simultaneous localization and mapping (SLAM), in which motion estimation is simultaneously estimated with environment features.

The motion estimation procedures described above are applied to four experimental datasets. The motion data recovered from the bathymetry data are compared with the motion data measured from the dedicated motion sensor. Statistics is provided summarizing the performance and note issues in the datasets that affect the estimation accuracy.

Factors that affect the estimation accuracy may include: influence of the sonar bathymetry resolution, instrument resolution, variation of seafloor terrain topology, and environment noise.

Note that in the generation of the test results presented herein, different choices of parameters x₀, xᵢ, a and f_{c}_{_{L}}, f_{c}_{_{H}} were used for data files for each bottom type in the datasets. This means, for example, that the same x₀, x₁, a and f_{c}_{_{L}}, f_{c}_{_{H}} were used for motion estimation for all data files flat*.k8e in the DEC20 dataset, but a different setting of x₀, x₁, a and f_{c}_{_{L}}, f_{c}_{_{H}} was used for all data files rocks*.k8e in the DEC20 dataset. Efforts were made to tune the parameters for good estimation performance. However, the estimation performance may be further improved by tuning the parameters for each data file individually.

Performance Metrics

In assessing the motion estimation performance, the following statistics is used. Let \check{φ}_{r(j) be the estimated roll angle and φ}ᵣ (j) be the Octans-measured roll angle at ping j, the mean and standard absolute estimate errors can be computed as:

$${\overline{E}}_{a} = \frac{1}{N} {\sum }_{j} e ( j ) , e ( j ) = \vert {{ψ}^{⋒}}_{r} ( j ) - {ψ}_{r} ( j ) \vert \\ {σ}_{r} = \sqrt{\frac{1}{N} {\sum }_{j} {( e ( j ) - {\overline{E}}_{a} )}^{2}} \qquad ( 10 )$$

The mean estimate error computed above contains a bias due to the bandpass filtering process as it removes the DC component in the estimated motion. A second set of error statistics can be computed, which compensates for this bias:

$$δ = \frac{1}{N} {\sum }_{j} ( {{ψ}^{⋒}}_{r} ( j ) - {ψ}_{r} ( j ) ) \\ {\overline{E}}_{r} = \frac{1}{N} {\sum }_{j} \tilde{e} ( j ) , \tilde{e} ( j ) = \vert {{ψ}^{⋒}}_{r} ( j ) - δ - {ψ}_{r} ( j ) \vert \\ {σ}_{r} = \sqrt{\frac{1}{N} {\sum }_{j} {( \tilde{e} ( j ) - {\overline{E}}_{r} )}^{2}} \qquad ( 11 )$$

Furthermore, the relative percentage of estimation error can be computed with respect to the dynamic range of the magnitude of the motion:

$${P}_{r} = \frac{{E}_{r}}{M} \times 100 ( \% ) , M = {max}_{j} ( \vert {ψ}_{r} ( j ) \vert$$

Statistics for the heave estimation can be computed in the same way.

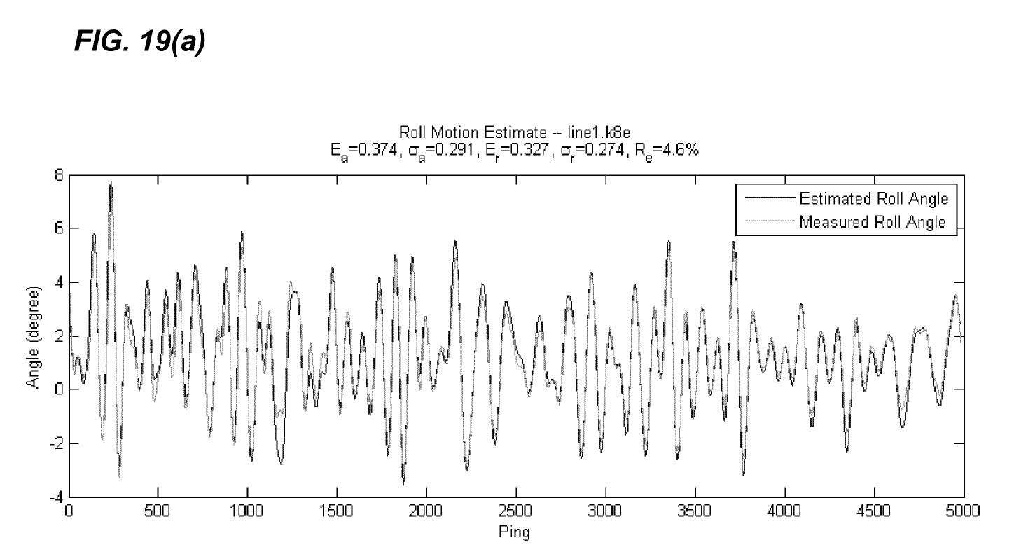

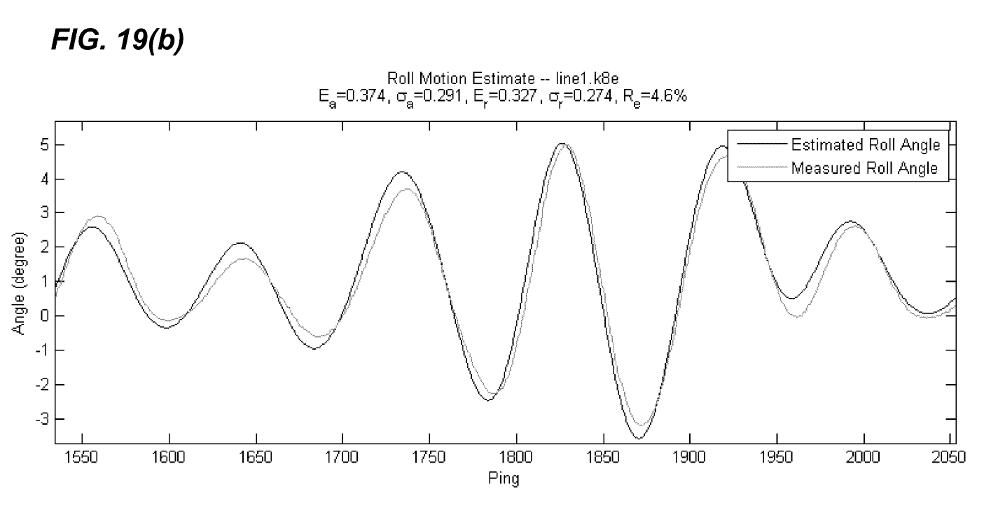

Test results show that the least-squares roll estimation scheme, after correcting for a constant offset, can be accurate to within 0.04°±0.03° (or 3% of the dynamic range) of the true roll motion in the best case, and to 0.2°±0.2° (6%) on average. FIG. 19(a) shows a comparison between the estimated roll motion, after an offset correction, and ground truth roll trajectory curves measured from the Octans sensor, for data file line1.k8e from dataset NOV16. FIG. 19(b) is a blow-up view of a segment of the curves in FIG. 19(a).

The estimation accuracy degrades to some extent when the seafloor terrain is rough or contains slopes. Nevertheless, the estimation is still sufficient to recover roll angle to within ˜0.5° degree of the measured roll motion overall (after correction using a constant offset) for most terrain conditions.

The results also show a non-zero offset between the estimated and measured motions. This offset is the combined result of sensor mounting bias and surface slope of the terrain.

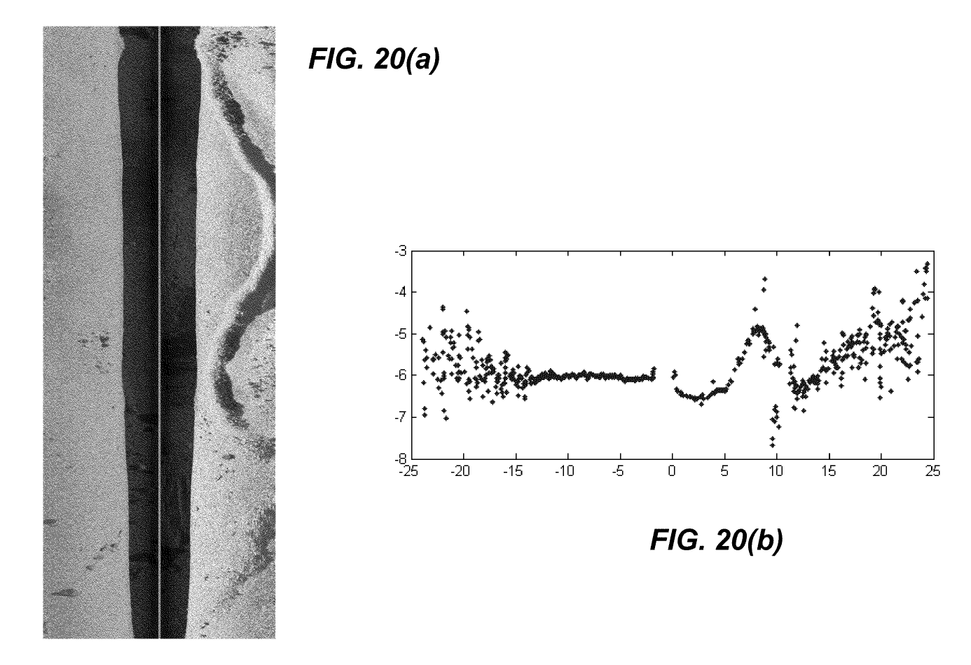

The largest roll estimation error comes from data files collected over a site where sediment has been piled on top of an outflow pipe. The pipe produces strong bathymetry measures that deviate significantly from the linear surface model. FIG. 20(a) illustrates sonar image of the data file pipe3turns25m.k8e, showing a pipe (the sensor moves in a zigzag fashion along the pipe). FIG. 20(b) illustrates motion-corrected bathymetry data obtained from the same data file at ping no. 2000, showing strong nonlinear surface depth across track.

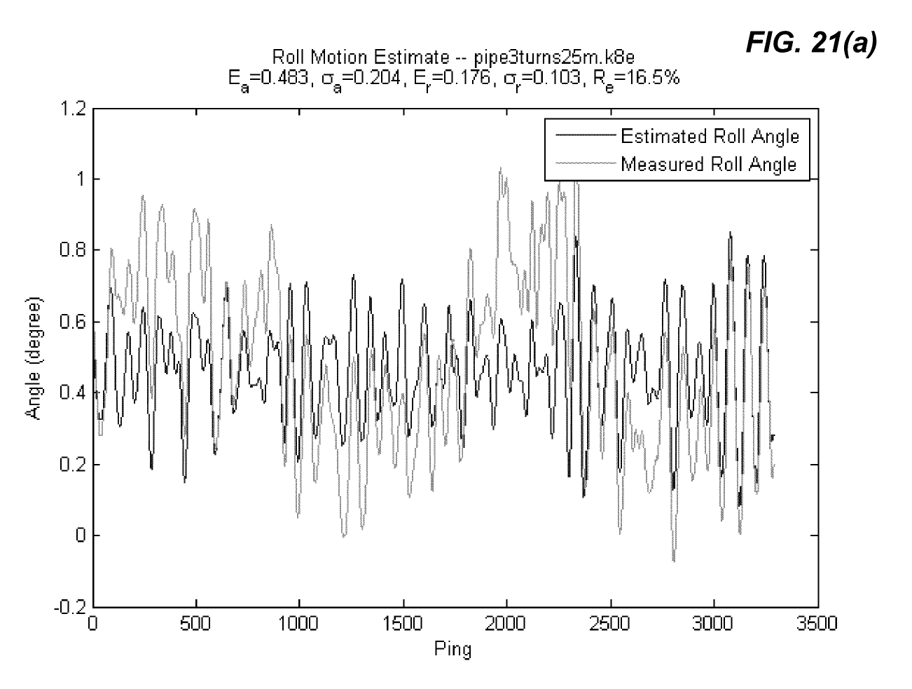

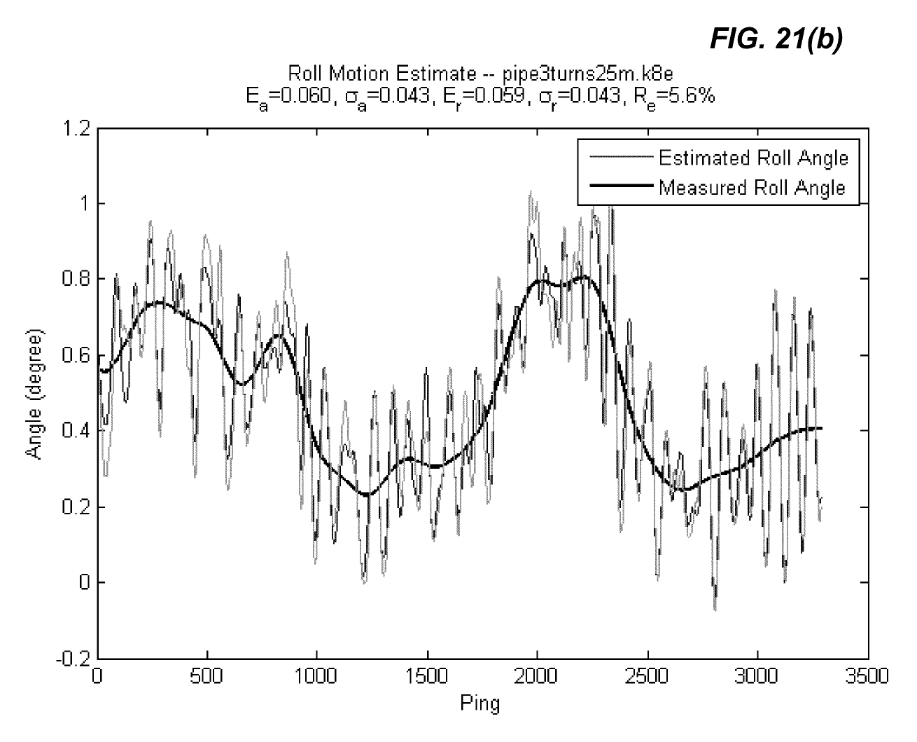

The spectrum bandpass filtering mitigated some of the artifacts in the estimated roll motion due to this nonlinear surface model. However, the bandpass filtering also removes any true motion component from the cut-off frequency bands. In the pipe data files the roll motion contains some low-frequency components which were removed in the estimated motion due to the spectrum filtering. The absence of these motion components contributed to the observed large error between the estimated motion and the true roll motion. The estimation accuracy can be significantly improved if the low-frequency ingredient of the roll motion can be preserved. For example, when this low-frequency component is retained in the roll estimate of the pipe3turns25m.k8e data file, (by extracting the missing spectrum band from the ground truth and adding it to the estimated roll), the estimation error is cut by more than a half, from 0.18° (16.5%) to 0.06° (5.6%), as illustrated in FIG. 21(a) and FIG. 21(b). Specifically, FIG. 21(a) illustrates roll estimate results after bandpass filtering, where the low frequency is filtered out, while the ground truth data contains low-frequency components. FIG. 21(b) shows that adding the missing low-frequency signal to the estimation motion improves the estimation accuracy.

On the other hand, if all low-frequency components in the estimated roll motion are preserved, the estimation error would be 17%. This indicates that the low-frequency components of the roll motion are mixed in the frequency band with other elements from the environment. The presence of this low-frequency true roll is aberrant in that the ship conducted slow turns during data collection, producing the low-frequency component of the motion. During normal operations, and for UUV applications, it is not expected to have significant navigation-induced low-frequency motion to impact the estimator in a substantial way.

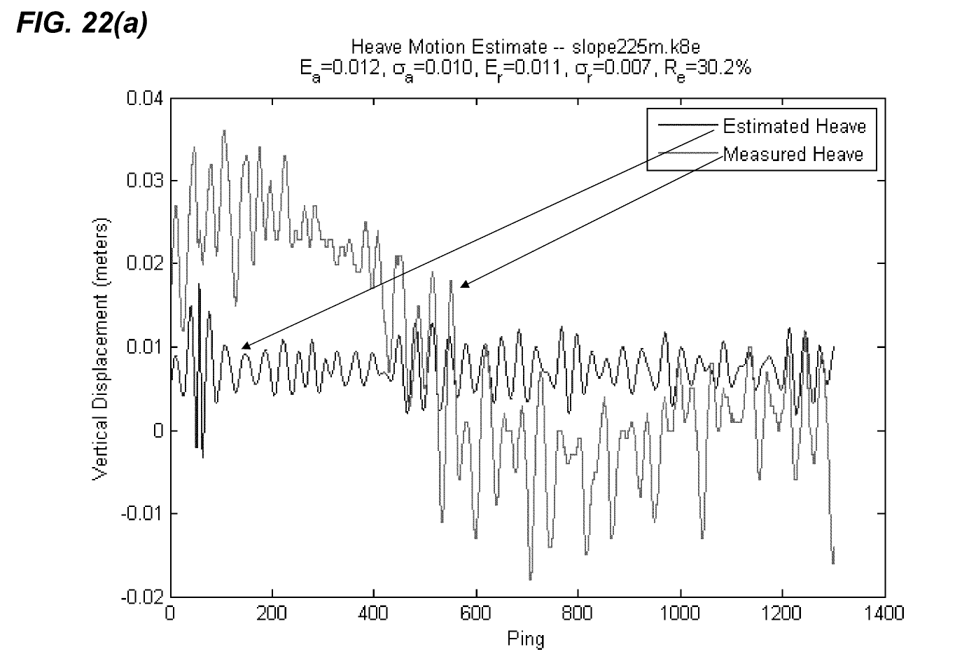

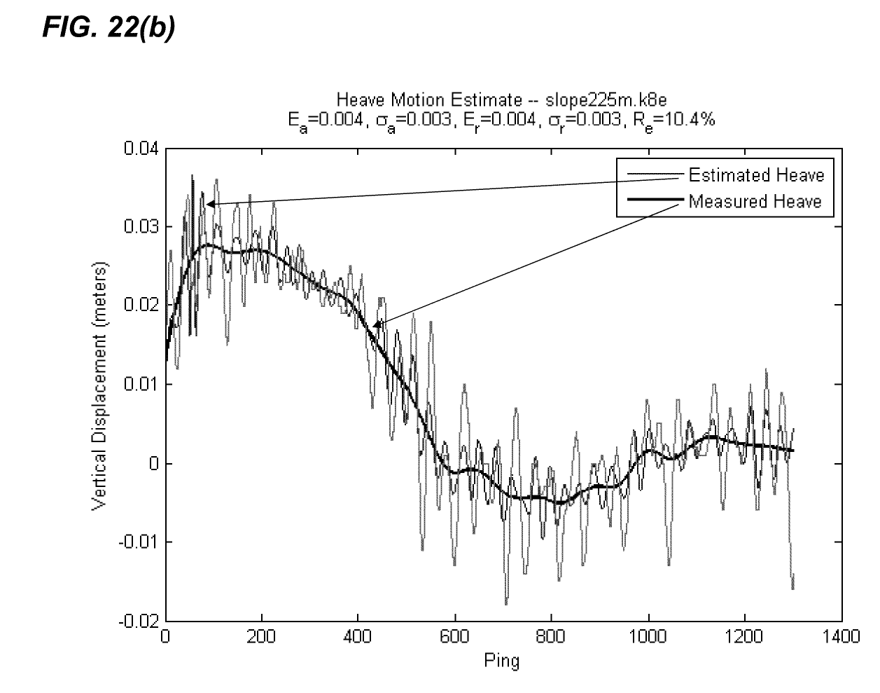

Low-frequency motion components have been observed in other data files, both in roll and heave motions. For example, FIG. 22(a) illustrates that low-frequency motion components still exist in bandpass-filtered heave estimation. FIG. 22(b) illustrates that adding the low frequency component back reduces error from 30.2% to 10.4%. The bandpass filtering process may be overly simplistic for such mixed signals. A further enhancement to the current motion estimation solution can include a signal de-mixing process to identify and separate the true motion components from environmental elements more accurately. These mixed signals are infrequent, and may be the result of the data collection methodology. A cursory look at motion data from the REMUS 600 SSAM vehicle would suggest that these mixed signals are far less likely than what were obtained from the C3D mounted on a surface vessel.

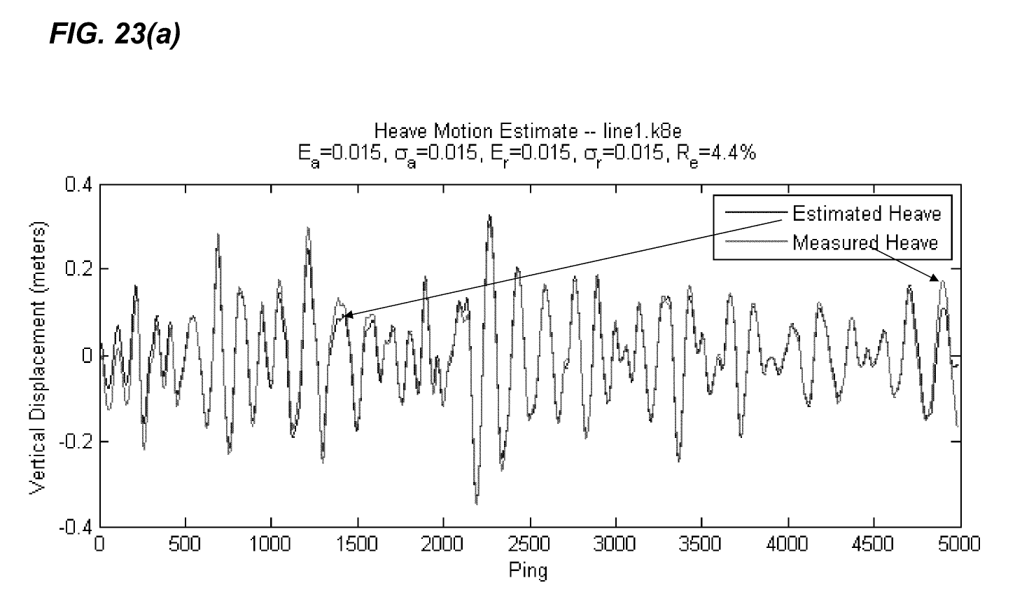

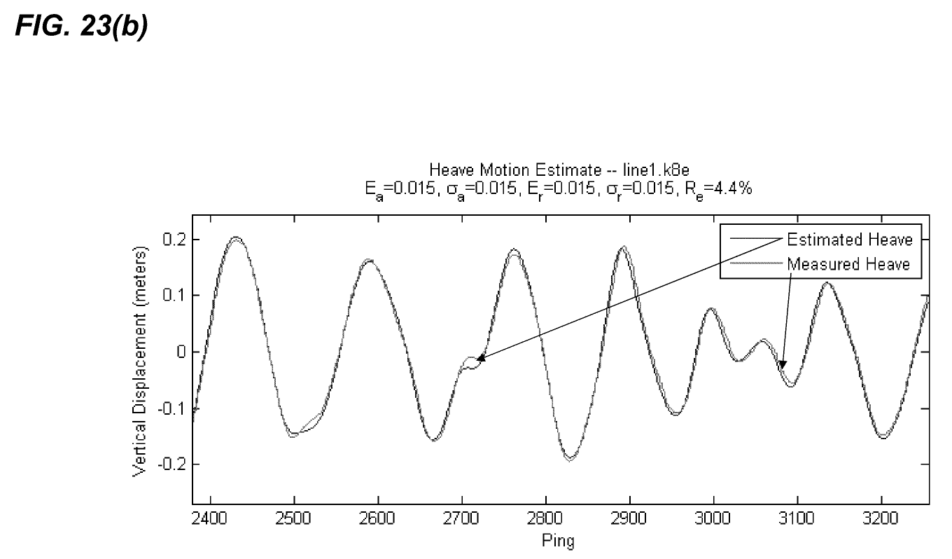

The results show that the estimated heave is within 2 cm±1 cm accuracy (or 16% of the dynamic range) in average to the measured motion. FIG. 23(a) illustrates the estimated (after a correction for a constant offset) and measured (using Octans) heave trajectory curves from the data file line1.k8e. FIG. 23(b) is a blow-up view of a segment of the curves in FIG. 23(a).

The relative error of the heave estimate is larger over rough and varied terrains. The worst estimate performance is again over the pipe site, whose terrain deviates significantly from the linear model. The slope variation of the seafloor terrain introduces a multiplicative random distortion to the heave estimate. To improve heave estimation accuracy further, a multiplicative noise removal process can be developed.

To assess the impact of inaccuracy in the roll estimate on the heave estimate, a baseline heave estimate is calculated using Octans-measured roll motion data. The least-squares fitting is first applied to estimate the apparent height at each ping. The roll and pitch motion is then corrected using the Octans-measured roll and pitch angles instead of the estimated angles. Heave is then computed using the same bandpass procedure. The results using the Octans-measured roll in the heave estimate computation are almost identical to the results reported above (only two data files showed very slight improvement in accuracy). This may result from that the original roll angle estimation was within 2° from the Octans measurements. The impact of such a small roll estimation error on heave estimate is negligible (cos(2°)>0.999).

The motion estimation computation in accordance with one embodiment utilizes the impact of sensor motion on the apparent depth measures of (\hat{x}ᵢ, \hat{z}ᵢ), which in turn are derived from the measured angle-of-arrival and range data. The accuracy of motion estimation is therefore dependent on the precision of these measurements.

Elevation Angle Precision

The sensitivity of apparent elevation measurement to data inaccuracy can be analyzed by taking the derivative of Eq. (1):

$$\partial {θ}_{a} = \frac{\partial {Δϕ}_{{R}_{1} , {R}_{2}}}{2 π} \frac{λ}{B} \frac{1}{cos ( ψ - θ )} \qquad ( 12 )$$

From Eq. (12) it can be obtained that the angle measure precision is proportional to the phase difference precision ΘΔφ_{R}_{₁}_{R}_{₂} and is more robust against data noise when:

$$\frac{λ}{B}$$

is small, i.e., for large spacing between transducers relative to signal wavelength; and

cos(θ−φ)≈1, i.e., for echo sources close to the interferometer axis.

Error Bound for C3D

For the C3D sensor, the sensitivity to errors can be computed in the phase measurement:

$$\vert \partial {θ}_{a} \vert = \vert \frac{\partial {Δϕ}_{{R}_{1} , {R}_{2}}}{2 π} \frac{λ}{B} \frac{1}{cos ( ψ - θ )} \vert \geq \vert \frac{\partial {Δϕ}_{{R}_{1} , {R}_{2}}}{2 π} \frac{λ}{B} \vert ( radians )$$

In the experiment, B=0.0035 m. The operating frequency of the transmitted pulse is 200 kHz, λ=7.5 ms, and|Θθₐ|≧19.54|ΘΔφ_{R}_{₁}_{, R}_{₂}|(degree). It can then be derived that a 0.01° inaccuracy in phase measurement will result in a ˜0.2° inaccuracy in elevation angle measurement for the C3D using the 200 kHz carrier frequency.

Phase Ambiguity for C3D

Phase-based interferometry typically is subject to phase ambiguity as phase is measured modulo 2π. Phase ambiguity occurs when:

$${Δφ}_{{R}_{1} , {R}_{2}} = \vert \frac{2 π}{λ} B sin ( ψ - θ ) \vert \geq π$$

For the C3D, this means that

$$sin ( ψ - θ ) \geq \frac{λ}{2 B} .$$

Since λ>2B for the operating frequency of the transmit pulse used in the experiments, phase ambiguity is not an issue for the data.

Altitude and Lateral Distance Precision

The error in elevation angle measurement would introduce a derivative term in the altitude estimate. The relative sensitivity of angle measurement error nn altitude estimate is:

$$\frac{dz}{z} = ctg θ \partial θ = \frac{\partial Δ {ϕ}_{{R}_{1} , {R}_{2}}}{2 π} \frac{λ}{B} \frac{ctg θ}{cos ( ψ - θ )} \qquad ( 13 )$$

From Eq. (13) it can be inferred that a given angle measurement error is more penalizing on altitude precision at grazing incidences (i.e., θ≈0° and less important at nadir.

On the other hand, the angle measurement error is more penalizing on the lateral distance computation at nadir (θ≈90°):

$$\frac{dx}{x} = - tg θ \partial θ = \frac{\partial {Δϕ}_{{R}_{1} , {R}_{2}}}{2 π} \frac{λ}{B} \frac{tg θ}{cos ( ψ - θ )}$$

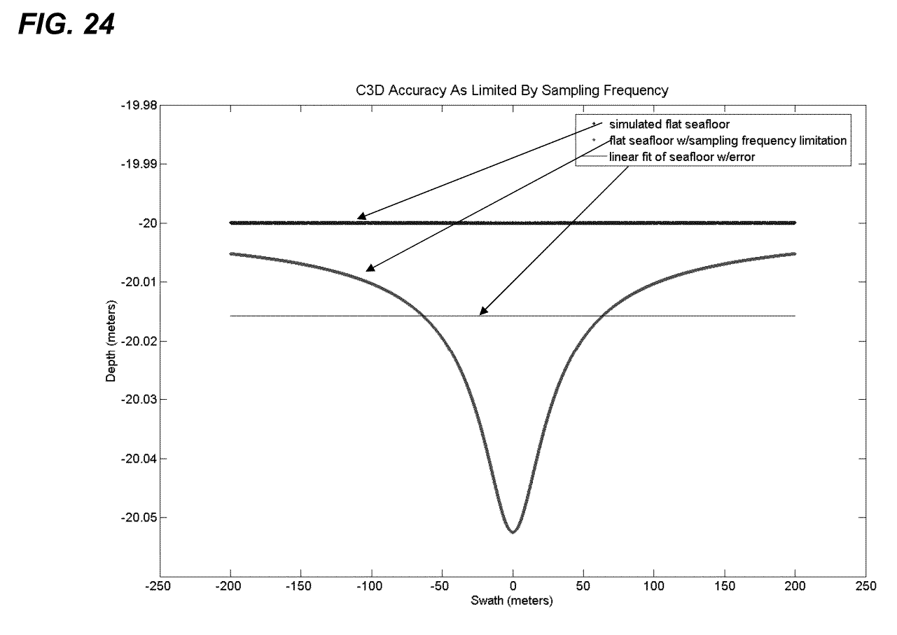

Finally, the range in the range, angle, and amplitude triplet is determined by the speed of sound in seawater, and the time of arrival of the echo at the transducer. This factor is fundamentally tied to the sampling frequency of the system. With a 14.286 kHz sampling frequency, the time of arrival can coincide with the actual beginning of the reflected tone, or up to 70 μsec later. The bounds of the point-wise range error on sampling frequency are shown in FIG. 24. Statistically, this factor is minimized by the randomness having a uniform distribution over the range, and the large quantity of points per ping. However, the statistics suggests that the final DC bias will be half the magnitude shown in FIG. 24.

Simulation of Estimation Accuracy

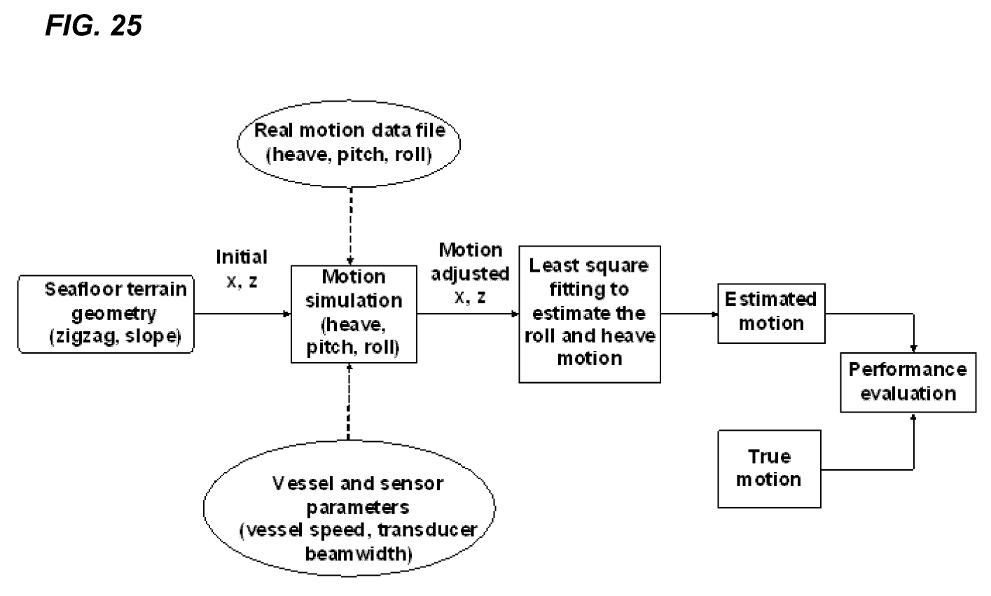

A simulation process is implemented to assess the estimate accuracy limit of roll and heave computation for each data file with respect to seafloor surface roughness and slope changes. FIG. 25 illustrates a flowchart of the simulation process for motion estimation performance.

A motion correction is first applied to the raw bathymetry data using the Octans-measured motion data. The cross track surface slope is then estimated at each ping using a least-squares fitting, and the standard deviation of the slope is computed from the motion-corrected data points at each ping. A set of artificial data points are then generated using the computed slope and standard deviation to simulate the variation of terrain geometry:

zᵢ=sxᵢ+z₀+nᵢ,

where s is the estimated slope at the ping, z₀ is a constant depth for all pings, and nᵢ is a random Gaussian noise N(0,σ), where σ is the estimated standard deviation from the data. The sensor motion can then be simulated to the artificial data by the physical relations detailed in earlier in this disclosure.

To assess the motion estimation accuracy, the motion estimation procedures are applied to these simulated data. The simulated data points could be viewed as an idealized version of the bathymetry data in each data file under the principle characteristics of the terrain geometry and sensor motion. The simulated data removed other factors such as surface depth variation along track, nonlinear surface curves, data inaccuracy at nadir and range limit, etc. from the data. Consequently, the estimated accuracy provides an estimate of the upper-bound of the estimation accuracy using the motion estimation procedures.

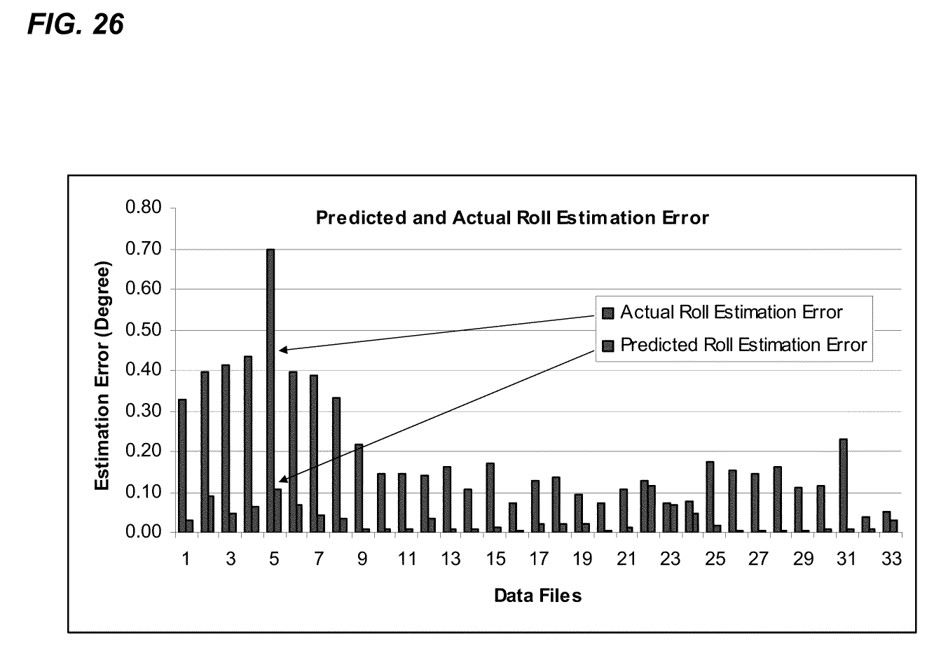

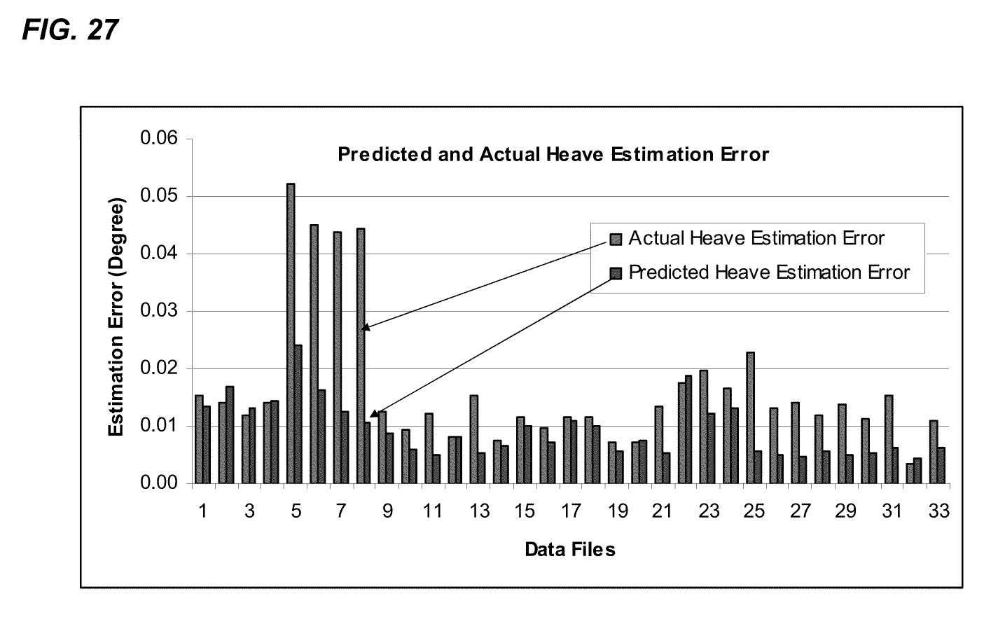

FIG. 26 and FIG. 27 show a comparison of the predicted roll and heave estimation errors for the data files in the four datasets. Specifically, FIG. 26 illustrates a comparison of predicted and actual roll estimation errors. The predicted roll estimation error in this chart indicates elimination of slope angle from roll estimation. FIG. 27 illustrates a comparison of predicted and actual heave estimation errors.

The figures show that the lower-limit of the roll estimation error is much lower than the actual error obtained in the experiments. This lower-bound may not be realistic as the error is computed assuming the distortion caused by linear slope across track can be perfectly removed (the predicted error is computed by removing the slope angle from the motion estimation). In actual data, distortions caused by slope variation cannot be perfectly removed. On the other hand, the simulation result shows that the roll estimation accuracy could be much higher with a better process of eliminating seafloor surface variation.

The predicted heave error does not remove the distortion caused by the surface slope and is much closer to the estimated error.

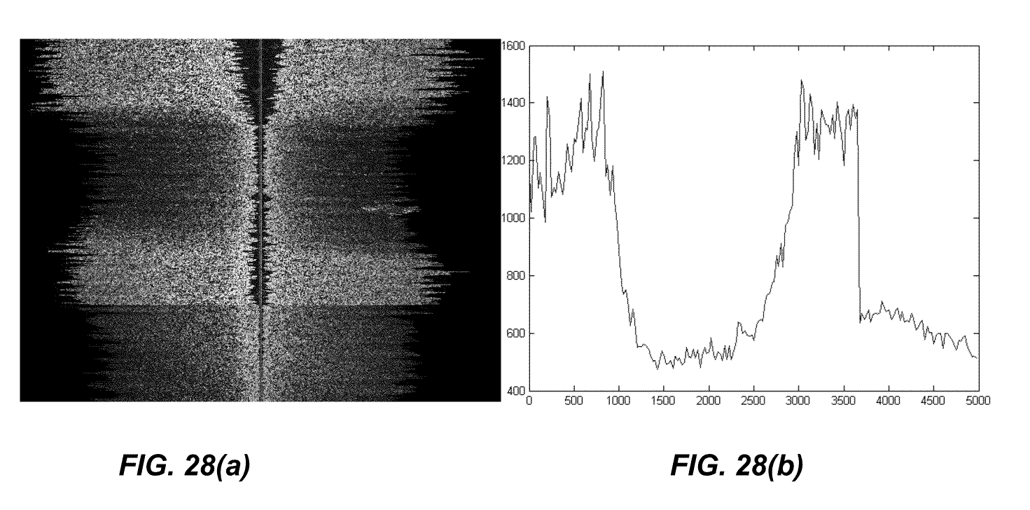

The raw bathymetry data contain a fair amount of variation in the amplitude and number of echoes recorded at each ping. Fewer range, angle, amplitude triplets were recorded in sections along track where the amplitude of echoes is low, suggesting little or weak backscattering from the seafloor. FIG. 28(a) illustrates an amplitude intensity image, showing significant variations from ping to ping in data file line1.k8e from Dataset Nov16. FIG. 28(b) illustrates the median amplitude per ping.

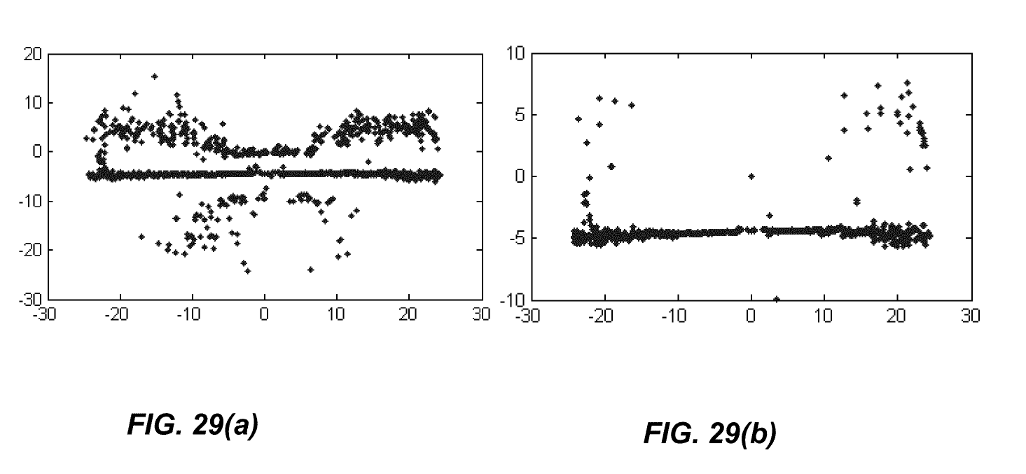

The Nov16 dataset includes examples of a seafloor with low acoustic reflectivity. Because the filtering algorithm is not real-time environmentally adaptive, more multipath solutions are included in the solution set than under more typical, higher-reflectivity conditions. In this flat-seafloor area, the cross-track bathymetry (x, z) computed from the measured range and angle data points are expected to be roughly linearly distributed. The actual plots show many outliers significantly off such an expectation. By removing data points whose amplitude is small, using a filtering algorithm, a significant portion of the outliers can be removed. For traditional survey operations, this can be part of the post-processing procedure. FIG. 29(a) is an (x, z) plot of all data points at ping 200 from the line1.k8e data file, illustrating the removal of outliers in bathymetry data. FIG. 29(b) is an (x, z) plot with data points of amplitudes>1000.

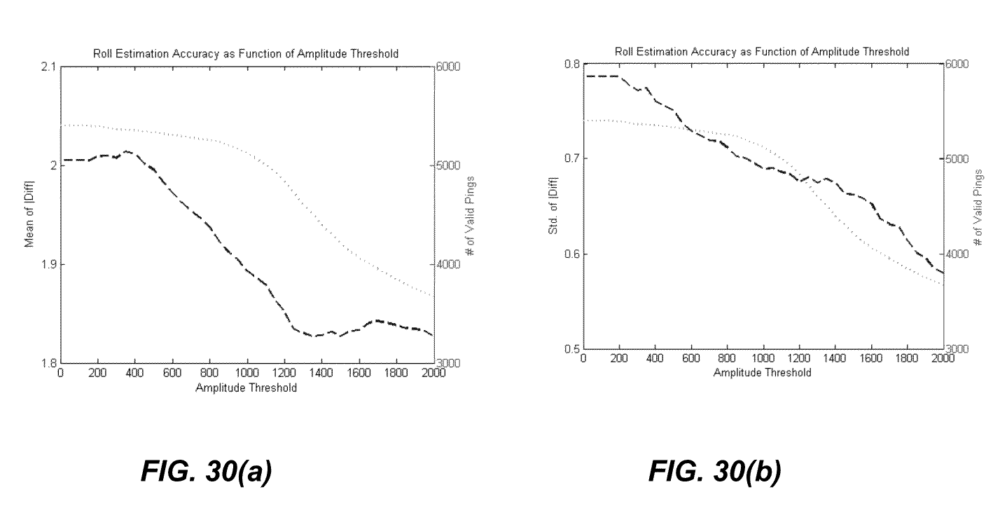

Outliers produced by weak backscattering data points contribute to inaccuracy and variations in the roll estimate. FIG. 30(a) illustrates that the roll estimation error decreases as the amplitude threshold increases (dashed line), where the mean values of absolute differences are plotted from the data file line3.k8e. FIG. 30(b) is a plot of standard deviations of the absolute differences. As shown, the roll estimation accuracy improves with larger amplitude threshold value. On the other hand, fewer pings contain a sufficient number of data points as the amplitude increases (dotted curves in FIG. 30(a) and FIG. 30(b)). In one example, a minimum threshold of 1000 is used in the experiments for this dataset in order to keep the majority of pings in the analysis.

Impact of a Sloped Seafloor

If the seafloor surface has a linear-slope, the slope affects the motion estimate in a variety of ways. A linear slope across track introduces an additive bias to the roll estimate at each ping equal to the angle of the slope. Variations in the slope along-track cause the bias in the roll estimate to vary from ping to ping.

A linear slope across track introduces a multiplicative bias to the water-column height estimate equal to 1/cos Θ, which implies that the heave estimate is affected by a linear slope via a multiplicative factor (heave estimate will also be affected if water-column depth variation exists along track in addition to cross-track slope).

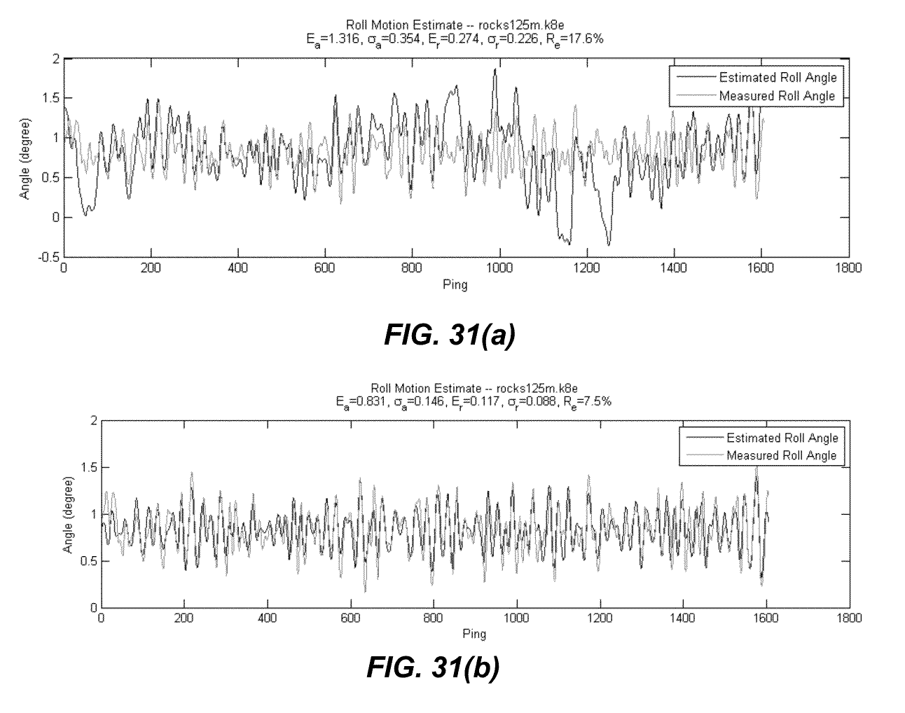

The additive bias in the roll estimation can be removed via spectrum filtering. Under normal operating conditions, the seafloor slope varies substantially slower than the roll motion. As a result, the bias in the roll estimation can be reduced via a low-pass filter, which segments the slope of the bathymetry data into a component due to motion and a component due to the slope of the seafloor. FIG. 31(a) and FIG. 31(b) illustrate an example of how spectrum filtering improves roll estimation accuracy by removing estimation distortion due to seafloor terrain variation. Specifically, FIG. 31(a) illustrates estimated roll angles from the data file rocks125m.k8e, which contain low-frequency components resulting from the cross-track slope variation. As shown, the estimation error is large. FIG. 31(b) illustrates the low-pass filtered estimated roll angles, where the artifacts caused by the slope variation are removed and the accuracy is substantially improved.

The bias introduced by the sloped surface to heave estimation requires a more sophisticated filtering process as it is a multiplicative stochastic process.

Impact of a Curved Surface

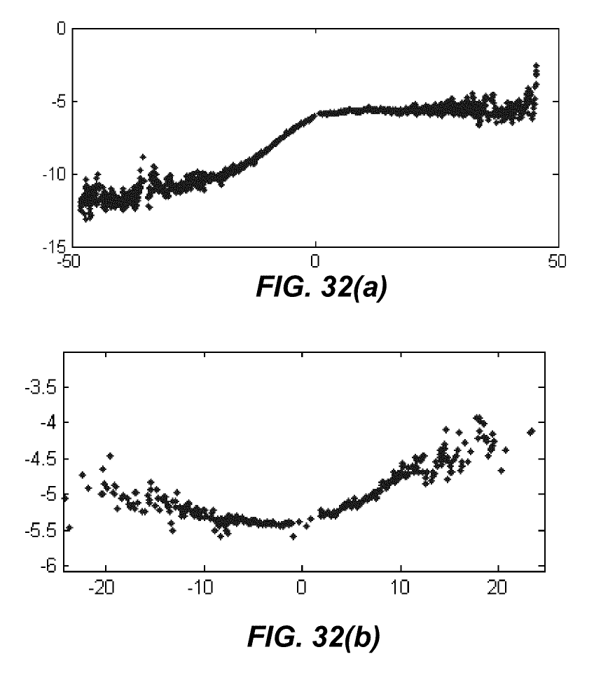

The seafloor surface may have a non-linear slope across-track. For example, FIG. 32(a) illustrates a plot of motioned-corrected (x, z) data, where a slope is present at one side and the other side of the surface is flat (from the data file slope225m.k8e @ ping1000). FIG. 32(b) illustrates data from another side showing a bowl-shaped seafloor surface (from the data file line2.k8e @ ping 5000).

Curves in the seafloor affect the motion estimation in a complex way. This nonlinearity violates the fundamental assumption to the analysis. Higher-order polynomial fitting only marginally improves the estimation accuracy (for polynomial of degree two) or no improvement at all (polynomial of >2 degrees). A more effective way of dealing with this nonlinearity is to incorporate the surface dynamics into the prediction and estimation model in the Kalman filter approach as suggested previously.

For a small-scale roll motion, the coefficient of the first-order term from the least-squares polynomial fitting approximately contains a constant term resulting from sensor roll and the linear slope of the surface, and a term which is a function of the higher-order surface shape. Consequently, the estimation of motion from a non-linear surface is biased in a complex way by the high-order surface variations. This high-order surface variation effect can be mitigated via a filtering process similar to that discussed earlier assuming the along-track surface variation is slower than the motion variation.

Impact of Surface Roughness

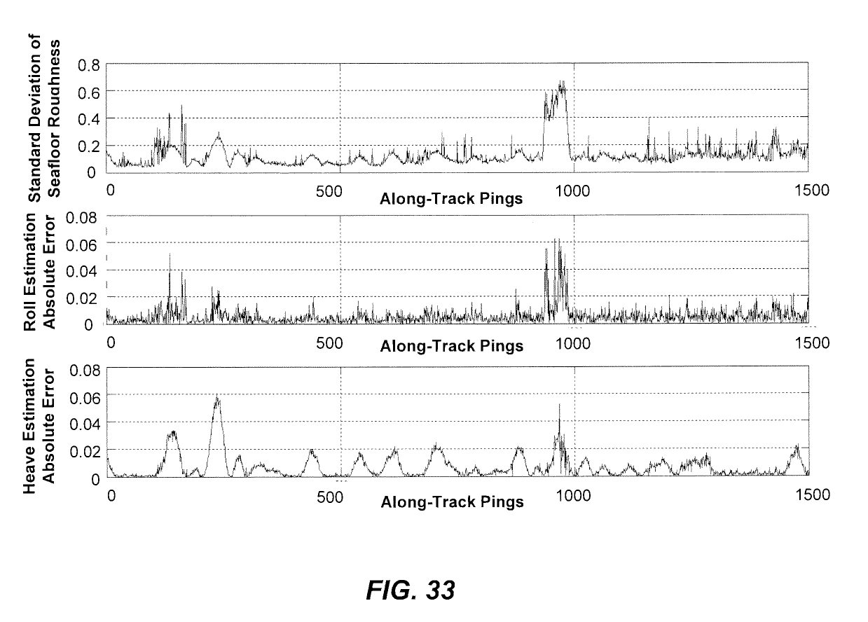

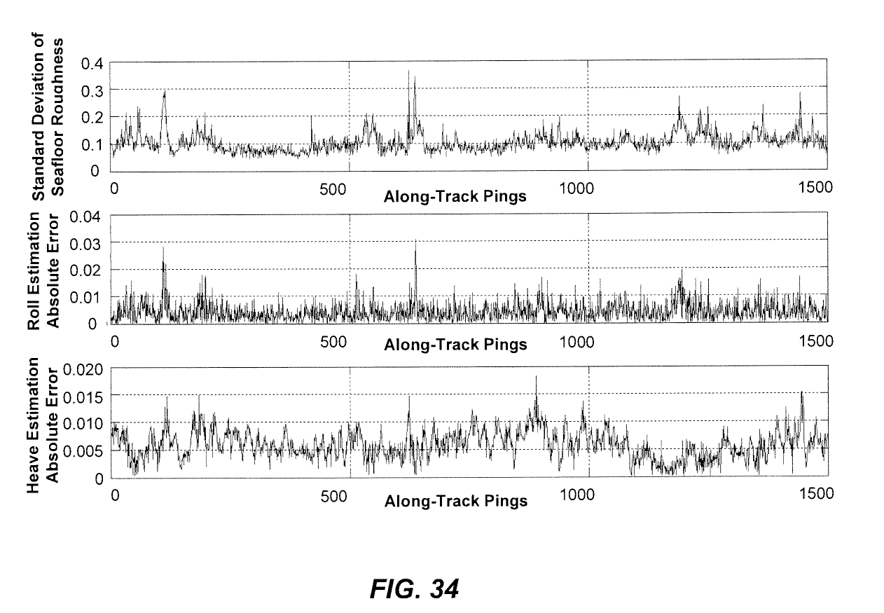

Seafloor surface roughness introduces random fluctuations to the surface height and surface slope, and can be correlated to the roll and heave estimation errors. FIG. 33 and FIG. 34 show the result of motion estimate from a simulated rough surface using motion and surface information from two different data files. Specifically, FIG. 33 illustrates a plot of surface roughness along track for the data file line1.k8e (top panel), a plot of absolute roll estimation error (middle panel), and a plot of absolute heave estimation error (bottom panel). FIG. 34 illustrates a plot of surface roughness along track for the data file rocks125m.k8e (top panel), a plot of absolute roll estimation error (middle panel), and a plot of absolute heave estimation error (bottom panel). Clearly, the estimate error is larger at pings with higher standard deviations.

As described above, it is possible to recover roll motion from C3D bathymetry data with reasonable accuracy up to a constant calibration offset under most terrain conditions.

Heave motion estimation can be contaminated with a multiplicative distortion if the seafloor terrain contains a slope or a higher-order variation across track. This multiplicative distortion introduces a stochastic spectrum shift to the estimated heave along track if their characteristics vary from ping to ping. Removing this multiplicative stochastic distortion requires a more sophisticated modeling of the terrain dynamics in the motion model.

Pitch, heave, and surface depth variations produce a compound change to the C3D bathymetry data. Consequently, pitch, heave, and seafloor depth cannot be recovered simultaneously from the bathymetry data alone. However, in most cases, the scale of pitch motion translates into extremely small variations in the bathymetry record. Because these variations are often below the detection threshold for C3D, the impact of pitch variations on the result can be omitted. In practice, decomposing heave and seafloor depth can be accomplished by spectrum filtering.

One issue in the motion estimation is the proper separation of certain motion components from contaminants from the environment. Simple spectrum filtering is inadequate when the motion shares spectrum characteristics with the environmental factors. However, such conditions may be anomalous. One possible alternative is to incorporate the terrain model simultaneously with the motion model in estimation. The least-square fitting-based scheme does not allow such incorporation of information on terrain model and motion dynamics into the estimation. The Kalman filtering is a more powerful approach as it can integrate constrains of motion dynamics across pings and surface variation dynamics into the motion prediction and estimation. It can potentially provide more accurate motion estimation and be more robust against environment changes.

Advantageously, methods, computer program product, apparatuses or systems disclosed herein allow motion, position, or navigation data to be “recovered” from sonar data without a reference motion or position sensor. Thus, existing interferometric sonar (e.g., C3D) can be improved by relaxing or eliminating their need for extra motion sensors for motion compensation. In addition, the algorithms can be used in interferometric synthetic aperture sonar (in SAS) to recover seafloor slope, which can in turn improve SAS resolution. Further, the algorithm can be used in AUV motion control, for example by providing self-orientation for a sensor normal.

From the recovered motion data, the position of the AUV can be derived. Thus, the methods disclosed herein can also provide a way of navigation, independent of GPS or INS.

The section headings used herein are for organizational purposes only and are not to be construed as limiting the subject matter described in any way.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

In this respect, various aspects of the invention, may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A method comprising:
iteratively fitting data obtained by an underwater sensor from interactions between acoustic signals and an underwater floor; and
deriving at least one of motion, position, or navigation data of the underwater sensor from said fitting.

2. The method of claim 1, further comprising, prior to said iteratively fitting, selecting the data by removing data points near nadir, data points near a data range limit, and data points with weak amplitudes.

3. The method of claim 1, wherein said fitting comprises:
removing data having a deviation higher than a first threshold from a first polynomial;
fitting remaining data to a second polynomial;
reducing the first threshold to a second threshold; and
removing data having a deviation higher than the second threshold from the second polynomial.

4. The method of claim 3, wherein the first and second polynomials are obtained from least-square fitting.

5. The method of claim 3, further comprising repeating said fitting remaining data to a second polynomial until deviations of data, survived from said removing data having a deviation higher than the second threshold from the second polynomial, are within a current threshold.

6. The method of claim 1, wherein said iteratively fitting data comprises iteratively fitting the data obtained from a single discrete transmission of the acoustic signals.

7. The method of claim 1, wherein the data are obtained from multiple discrete transmissions of the acoustic signals, the method further comprising determining whether the data are sufficient for statistics over the multiple discrete transmissions.

8. The method of claim 7, further comprising applying a Bayesian statistics to the data obtained from the multiple discrete transmissions.

9. The method of claim 8, wherein said applying a Bayesian statistics comprises applying a recursive filter.

10. The method of claim 9, wherein said recursive filter comprises a nonlinear Kalman filter.

11. The method of claim 10, wherein the nonlinear Kalman filter comprises an Unscented Kalman Filter.

12. The method of claim 8, further comprising providing at least one of a dynamic model of the motion of the sensor or a dynamic model of the underwater floor variation.

13. The method of claim 1, wherein the derived motion, position, or navigation data comprise:
a first component from the motion of the sensor; and
a second component from the underwater floor variations.

14. The method of claim 13, further comprising separating the first and second components from the data.

15. The method of claim 13, further comprising obtaining the motion data of the sensor from the first component.

16. The method of claim 13, wherein the motion comprises a heave motion, and wherein the second component comprises a multiplicative component introduced by a slope of the underwater floor to the first component, the method further comprising removing the multiplicative component.

17. The method of claim 13, wherein the motion comprises a roll motion, and wherein the second component comprises an additive component introduced by a slope of the underwater floor to the first component, the method further comprising removing the additive component.

18. The method of claim 1, wherein said deriving is performed without a motion or position sensor.

19. The method of claim 1, further comprising:
applying spectrum filtering to the derived motion, position, or navigation data to correct for underwater floor variations.

20. The method of claim 19, wherein said applying spectrum filtering comprises applying a low-pass filter.

21. The method of claim 8, further comprising performing a joint state-parameter estimation over the data to separate a bias in the data introduced by the underwater floor variation.

22. The method of claim 21, further comprising:
dividing a track in the underwater floor into a plurality of segments each having a substantially linear slope; and
estimating the plurality of slopes as a plurality of model parameters in a nonlinear Kalman filter applied to the data.

23. A system comprising:
a transducer array to transmit acoustic signals underwater to interact with an underwater floor; and
a processor to process data obtained from interactions between the acoustic signals and the underwater floor, wherein the processor is configured to:
iteratively fitting data obtained by an underwater sensor from interactions between acoustic signals and an underwater floor; and
deriving at least one of motion, position, or navigation data of the underwater sensor from said fitting.

24. The system of claim 23, wherein the system is a standalone system without a motion or position sensor.

25. A non-transitory computer readable medium having instructions stored thereon, wherein the instructions comprise:
iteratively fitting data obtained by an underwater sensor from interactions between acoustic signals and an underwater floor; and
deriving at least one of motion, position, or navigation data of the underwater sensor from said fitting.

26. The non-transitory computer readable medium of claim 25, wherein said iteratively fitting comprises:
removing data having a deviation higher than a first threshold from a first polynomial;
fitting remaining data to a second polynomial;
reducing the first threshold to a second threshold; and
removing data having a deviation higher than the second threshold from the second polynomial;
repeating said fitting remaining data to a second polynomial until deviations of data, survived from said removing data having a deviation higher than the second threshold from the second polynomial, are within a current threshold.
